(19) United States
(12) Patent Application Publication
(10) Pub. No.: US 2026/0115506 A1
(43) Pub. Date: Apr. 30, 2026

(54) RETROFITABLE CONTINUOUS FIT MONITORING FILTERING FACEPIECE RESPIRATORS, SYSTEM, AND METHOD

(71) Applicant: Georgia Tech Research Corporation, Atlanta, GA (US)

(72) Inventors: Sundaresan Jayaraman, Atlanta, GA (US); Sungmee Park, Atlanta, GA (US)

(21) Appl. No.: 18/927,445

(22) Filed: Oct. 25, 2024

(51) Int. Cl. A62B 27/00; A62B 18/08; B32B 5/02; B32B 5/26

(52) U.S. Cl. CPC A62B 27/00; A62B 18/08; B32B 5/022; B32B 5/26; B32B 2307/202; B32B 2571/00

(57) ABSTRACT

An exemplary system and method for a retrofittable respiratory protective device system configured to be retrofitted into a respiratory protective device for continuously monitoring the fit or proper particulate-filtering operation of the respiratory protective device. The system can ensure proper operation of the respiratory protective device while providing quantification of the fit and proper setup of the RPD as well as the on-going monitoring and tracking of the fit to ensure personal safety for users wearing the device.

### BACKGROUND

Workers and healthcare professionals are required to wear respiratory protective devices (RPD) in various workplaces and medical settings throughout the United States. Respiratory protective devices protect workers against harmful inhalation hazards, such as dust, fog, smoke, mist, gas, vapor, spray, and biological hazards or weapons.

Respiratory protective devices protect the user in two basic ways. The first class of devices protects the user by removing contaminants from the air. This first class of devices includes particulate respirators, which filter out airborne particles, and air-purifying respirators with cartridges/canisters, which filter out chemicals, biological material, and gases. The second class of devices protects the user by supplying clean respirable air from another source. This second class of devices includes airline respirators, which use compressed air from a remote source, and self-contained breathing apparatus (SCBA), which include their own air supply.

Air-purifying respirators (APRs) can be configured with different types of filter configurations, N95, N99, N100, R95, R99, R100, P95, P99, P100, and HE. Filtering facepiece respirators (FFR) are manufactured in discrete sizes and shapes that limit the options to accommodate the size, gender, and ethnic diversity in the user population when needed. The pressure exerted by a respiratory protective device, such as an N95 FFR, on the faceseal influences the comfort and tolerability of the user.

There is a benefit and/or a need to improve respiratory protective devices and their usage.

### SUMMARY

An exemplary system and method are disclosed for a retrofittable respiratory protective device system configured to be retrofitted into a respiratory protective device for continuously monitoring the fit or proper particulate-filtering operation of the respiratory protective device (RPD). Throughout this disclosure, an “RPD” may be defined as any device designed to protect the wearer's respiratory tract against the inhalation of a hazardous atmosphere that claims to meet a recognized voluntary consensus standard (e.g., ASTM, ANSI) or national regulation/standard (e.g., 42 CFR Part 84) that includes an assessment of minimum filtration efficiency level. The disclosed system can ensure proper operation of the respiratory protective device (RPD) while providing quantification of the fit and proper setup of the RPD (e.g., in annual fit-testing) as well as the on-going monitoring and tracking of the fit to ensure personal safety for users (e.g., healthcare professionals) wearing the device. The disclosed system can provide a quantitative metric or indicator to provide a sense of security of their personal safety upon which the user can depend to know that the RPD has been donned correctly.

The pressure exerted by the respirator on the face at the interface affects both the comfort of the wearer and the leakage at the interface, the faceseal. It is observed that there is a progressive decline in the loads generated by the top and bottom tethering devices during repeated donning and doffing of various N95 filtering facepiece respirators (FFRs) tested. The change in load on the faceseal could alter the “fit” of the respirator leading to leakages and thereby compromising the degree of rated protection from the device. Studies, referenced herein, have shown that the pressure exerted by the tethering devices is inversely proportional to the contact surface areas of the faceseal. There are many filtering facepiece respirators manufactured by multiple manufacturers. However, they are manufactured in a few sizes only and may not fit the unique facial features of the user. Thus, finding and fitting the right FFR for a user can be challenging; furthermore, the facial profile of the user changes during its use, which could compromise the fit of the device.

The disclosed systems and methods are responsive to changes in the fit of the RPD by, for example, alerting a user's device to a pressure change that exceeds expected values, e.g., at annual-fit test or in an on-going manner. The sensor network adhered to the RPD may be implemented into a variety of structures or platforms conformable to various respiratory protective devices. For example, sensor networks may be implemented into a reusable platform conformable to existing respiratory protective devices (e.g., off-the-shelf N95 respirators).

The sensor networks and platforms disclosed herein are unobtrusive to the user and do not impede the certified performance of the RPD or filtering facepiece respirator (FFR). By continuously monitoring the fit, a manual “user seal check” may be eliminated from a user's daily operations. Furthermore, the system can track faceseal pressure over time, collecting and interpreting data about the pressure value and leakage instances, building a big data set that may be used for additional design improvements. In one example, the sensor may be made of fabric to facilitate improved fit and comfort.

According to one aspect, a system is disclosed. The system includes a sensor network and a signal processing module. The sensor network is configured to couple to an inner surface of a respiratory protective device adjacent to a periphery of the respiratory protective device. The respiratory protective device maintains a breathable filter covering over a facial region of a user. The sensor network includes at least one sensor, including a first sensor, disposed adjacent to the periphery of the respiratory protective device. The at least one sensor is configured to detect pressure or proximity between the periphery of the respiratory protective device and the facial region of the user. The signal processing module is in operative communication with the at least one sensor. The signal processing module is configured to continuously receive and process pressure and/or proximity data from the at least one sensor to produce pressure values and monitor the fit of the respiratory protective device.

In some implementations, the signal processing module further includes a communication interface configured to wirelessly communicate with a controller. The controller is configured to (i) receive the pressure values, (ii) generate a notification based on the pressure values, and (iii) relay the notification to activate one of a display on a user interface, an audio device, or a haptic device.

In some implementations, the controller is configured to output the pressure values to a monitoring application (e.g., an Android phone application).

In some implementations, the controller is configured to generate an alert notification upon detecting that the pressure values from one or more sensors of the at least one sensor have dropped below a threshold value (e.g., a baseline value).

In some implementations, the controller is configured to generate an alert notification upon detecting that the pressure values from one or more sensors of the at least one sensor have risen above a threshold value (e.g., a maximum facial pressure value).

In some implementations, the controller is configured to remove the alert notification upon detecting that the pressure values from a sensor of the at least one sensor have returned to a predetermined range.

In some implementations, the sensor network is adhered to the respiratory protective device with an adhesive material (e.g., scar tape) such that the first sensor of the at least one sensor is adhered to a customized position along the periphery of the respiratory protective device.

In some implementations, the sensor network is disposed on a peripheral platform of the respiratory protective device, the peripheral platform including wings or flaps for holding each sensor of the at least one sensor.

In some implementations, the peripheral platform is integrated into the respiratory device (e.g., during manufacturing).

In some implementations, the first sensor is a fabric-based sensor including a first conductive fabric layer and a second conductive fabric layer separated by a resistive fabric layer; a first base layer coupled to the first conductive fabric layer. The fabric-based sensor further includes a second base layer coupled to the second conductive fabric layer.

In some implementations, the first base layer is a typical nonconductive fabric layer (e.g., including cotton or other common fibers). The first base layer is coupled to the first conductive fabric layer via adhesive, sewing, or bonding.

In some implementations, the system further includes a first fabric frame disposed between the first conductive fabric layer coupled to the first base layer and the resistive fabric layer, the first fabric frame configured to provide enhanced structural integrity to the first sensor.

In some implementations, the first and second conductive fabric layers have a surface resistivity less than 1 Ohm/cm².

In some implementations, the resistive fabric layer has a surface resistivity of greater than 31,000 Ohm/cm².

In some implementations, the first conductive fabric layer is coupled to the signal processing module via a data wire (e.g., conductive yarn), and the second conductive fabric layer is coupled to the signal processing module via a power wire (e.g., conductive yarn).

In some implementations, each sensor of the at least one sensor is adhered at a customized location on the respiratory protective device based at least on the facial region of the user.

In some implementations, the customizable location on the respiratory protective device is one or more of a nose position, an upper-cheek position, a mid-cheek position, and a chin position.

In some implementations, the respiratory protective device is an N95 respirator.

In some implementations, the sensor network is removable from the respiratory protective device, capable of decontamination, and reusable.

According to another aspect, a method of monitoring fit of a respiratory protective device is disclosed. The method includes providing a system, the system including a sensor network and a signal processing module. The sensor network is configured to couple to an inner surface of a respiratory protective device adjacent to a periphery of the respiratory protective device. The respiratory protective device maintains a breathable filter covering over a facial region of a user. The sensor network includes at least one sensor, including a first sensor, disposed adjacent to the periphery of the respiratory protective device. The at least one sensor is configured to detect pressure or proximity between the periphery of the respiratory protective device and the facial region of the user. The signal processing module is in operative communication with the at least one sensor. The signal processing module includes a communication interface configured to wirelessly communicate with a controller. The method further includes continuously receiving, via the signal processing module, pressure and/or proximity data from the at least one sensor. The method further includes continuously receiving, via the controller, pressure values from the signal processing module, and generating, via the controller, a notification based on the pressure values.

In some implementations, the method further includes relaying, via the controller, the notification to activate one of a display on a user interface, an audio device, or a haptic device.

In some implementations, the method further includes relaying, via the controller, the pressure values to a monitoring application (e.g., an Android phone application).

In some implementations, the method further includes generating, via the controller, an alert notification upon detecting that the pressure values from one or more sensors of the at least one sensor have dropped below the threshold value (e.g., a baseline value).

In some implementations, the method further includes generating, via the controller, an alert notification upon detecting that the pressure values from one or more sensors of the at least one sensor have risen above a threshold value (e.g., a maximum facial pressure value).

In some implementations, the method further includes removing, via the controller, the alert notification upon detecting that the pressure values from a sensor of the at least one sensor have returned to a predetermined range.

In some implementations, the sensor network is adhered to the respiratory protective device with an adhesive material (e.g., scar tape) such that the first sensor of the at least one sensor is adhered to a customized position along the periphery of the respiratory protective device.

In some implementations, the sensor network is disposed on a peripheral platform of the respiratory protective device, the peripheral platform including wings or flaps for holding each sensor of the at least one sensor.

In some implementations, the method further includes integrating the peripheral platform into the respiratory protective device (e.g., during manufacturing or attaching via adhesive).

In some implementations, the first sensor is a fabric-based sensor including: a first conductive fabric layer and a second conductive fabric layer separated by a resistive fabric layer; a first base layer coupled to the first conductive fabric layer; and a second base layer coupled to the second conductive fabric layer.

The systems, methods, and devices are explained in even greater detail in the following drawings. The drawings are merely exemplary and certain features may be used singularly or in combination with other features. The drawings are not necessarily drawn to scale.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF DRAWINGS

FIGS. 1A and 1B each illustrate an example of a continuous fit monitoring system for a sensor-integrated respiratory protective device (RPD) or customizable device of the same, in accordance with an illustrative embodiment.

FIG. 1C illustrates an example of a continuous fit monitoring system including a sensor-integrated peripheral platform retrofitted with a respiratory protective device (RPD), in accordance with an illustrative embodiment.

FIG. 2 is a diagram showing an example implementation of a continuous fit monitoring system of FIGS. 1A, 1B, or 1C, according to one implementation.

FIGS. 3A and 3B are flowcharts depicting example methods of operation to continuously monitor the fit of a respiratory protective device, according to one implementation.

FIG. 4 is a diagram showing a continuous fit monitoring system with various technology blocks describing the operation thereof, according to one implementation.

FIG. 5A shows a diagram of a fabric-based sensor, its components, and the assembly thereof, according to one implementation.

FIG. 5B shows a diagram of a fabric-based sensor, its components, and the assembly thereof, according to another implementation.

FIG. 6A shows a sensor network including five sensors, according to one implementation.

FIG. 6B shows the sensor network of FIG. 6A with exemplary locations for adhering the sensors to a filtering facepiece respirator, according to one implementation.

FIG. 7A shows a diagram of the components in a continuous fit monitoring system and network, showing the communication between each component, according to one implementation.

FIG. 7B shows a circuit diagram of an exemplary PCB, according to one implementation.

FIG. 7C shows an image of the exemplary PCB and its connectors, according to one implementation.

FIG. 8A shows a respiratory protective device (RPD) including a modular sensor network adhered thereto, according to one implementation.

FIG. 8B shows a peripheral platform with and without a sensor network adhered thereto, according to one implementation.

FIG. 8C shows a diagram of a peripheral platform and its connection to a filtering facepiece respirator, with and without a continuous fit monitoring system, according to one implementation.

FIG. 8D shows a diagram of a peripheral platform and its connection to a filtering facepiece respirator, with and without a continuous fit monitoring system, according to another implementation.

FIG. 8E shows a diagram of a peripheral platform and its connection to a filtering facepiece respirator, with and without a continuous fit monitoring system, according to another implementation.

FIG. 8F shows the front and back views of a peripheral platform adhered to a filtering facepiece respirator, according to one implementation.

FIGS. 9A-9C each shows an example user interface for monitoring the fit of a sensor-integrated respiratory protective device, according to one implementation.

FIG. 10A shows a diagram of an app user interface displaying heatmaps of the pressures (ADC values) at the five sensors in a network, according to one implementation.

FIG. 10B shows a diagram of baseline pressure profiles for two filtering facepiece respirators, according to one implementation.

FIG. 10C shows a diagram of the pressure distribution at the faceseal when a leakage was introduced during the Real-time Fit Check mode for both the FFRs on the same subject, according to one implementation.

FIG. 10D shows a diagram of the pressure distribution at the faceseal when external forces are applied to them during the testing, according to one implementation.

### DETAILED DESCRIPTION

Each and every feature described herein, and each and every combination of two or more of such features, is included within the scope of the present disclosure, provided that the features included in such a combination are not mutually inconsistent.

The citation and/or discussion of such references is provided merely to clarify the description of the present disclosure and is not an admission that any such reference is “prior art” to any aspects of the present disclosure described herein. In terms of notation, “[n]” corresponds to the nth reference in the list. All references cited and discussed in this specification are incorporated herein by reference and to the same extent as if each reference was individually incorporated by reference.

### Continuous Fit Monitoring System—Introduction

Provided herein are generic system diagrams, flowcharts, and corresponding descriptions related to a continuous fit monitoring system. Any individual element or elements of the continuous fit monitoring system may be improved upon or modified, as further described below in the “Improved Sensing Devices, Systems, and Methods for Continuous Fit Monitoring” section. Additionally, any element(s) of the generic systems and devices below may be combined with a modified or improved portion of the system, as further described below.

### Example System #1

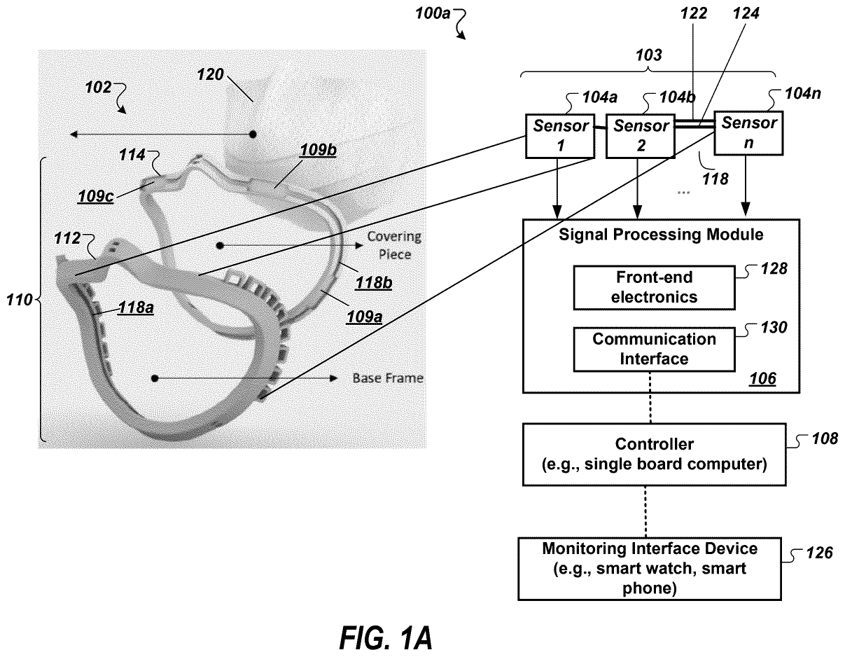

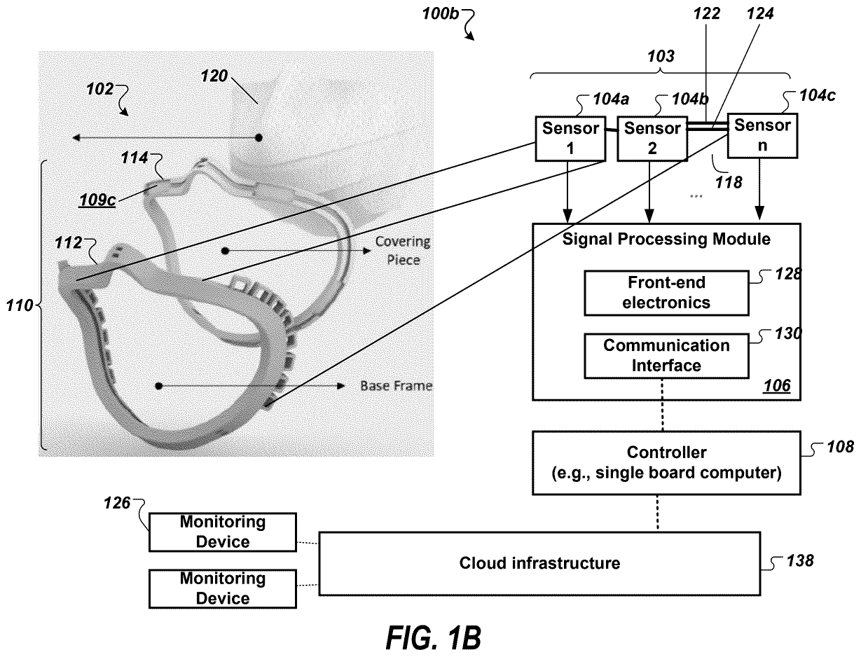

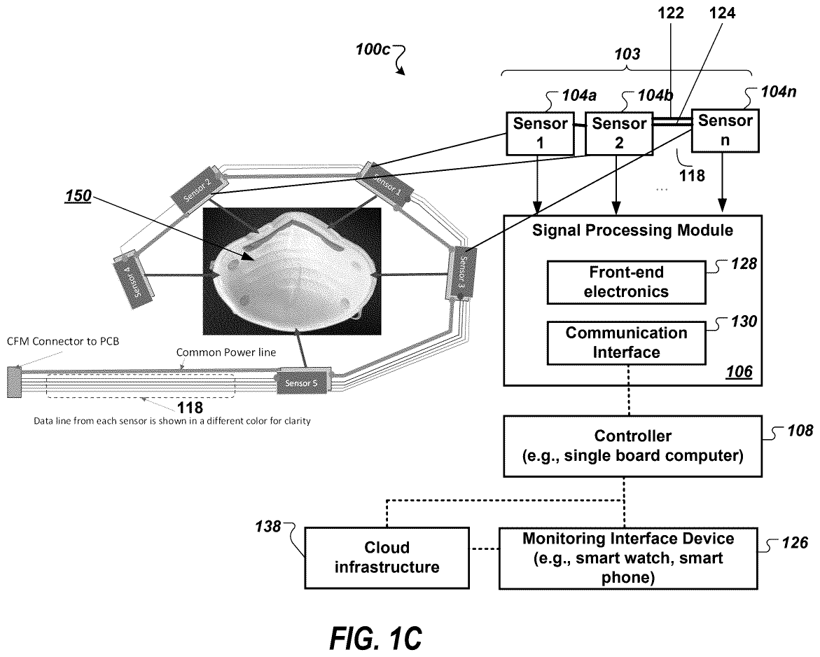

FIGS. 1A, 1B, and 1C each illustrate an example of a continuous fit monitoring system 100 (shown as 100a, 100b, and 100c, respectively) for a sensor-integrated respiratory protective device (RPD). FIG. 1A shows the continuous fit monitoring system 100a configured as a stand-alone monitoring device. FIG. 1B shows the continuous fit monitoring system 100b configured as a cloud-networked device. FIG. 1C shows a retrofitted continuous fit monitoring system 100c including a sensor network adhered to an off-the-shelf filtering facepiece respirator (e.g., an N95 respirator).

In the examples shown in FIGS. 1A-1C, the sensor-integrated respiratory protective device includes a sensor network 103 comprising a set of one or more sensors 104 (shown as “sensor 1” 104a, “sensor 2” 104b, to “sensor n” 104n), a signal processing module 106, and a controller 108. In the example shown in FIGS. 1A and 1B, a custom-fit respiratory device 102 is shown, as further described below. According to another implementation, the example shown in FIG. 1C includes an off-the-shelf respiratory protective device 150 that is retrofitted with the sensor network 103.

The system 100c of FIG. 1C, including the retrofitted respiratory protective device 150, is capable of continuously monitoring the fit or proper particular filtering operation of the retrofitted respiratory protective device 150. For example, the system 100c can provide quantification of the proper fit and setup of the RPD 150 (e.g., in annual fit testing) as well as the on-going monitoring and tracking of the fit to ensure personal safety for users (e.g., healthcare professionals) wearing the device. Thus, the exemplary system 100c can provide a quantitative metric or indicator to provide a sense of security of their personal safety upon which the user can depend to know that the RPD has been donned correctly.

A wide variety of filtering facepiece respirators is available from various manufacturers. However, the limited options for size and shape of the respirator limit the options for users. Finding a respirator to fit a specific facial structure can be challenging. Furthermore, normal facial movements may alter the fit of the respirator, and repeated donning and doffing of the respirator also lead to leakages.

The disclosed systems and methods, including the system 100c of FIG. 1C, are responsive to changes in the fit of the RPD 150 by, for example, receiving pressure data from the sensor network 103, processing the data, and communicating an alert to a user's device to pressure change.

Custom fit device. Referring to FIG. 1A, the respiratory protective device 102 includes a frame 110 (e.g., custom fit or otherwise as described herein) comprising a first portion 112 (shown as a “base frame”) and second portion 114 (shown as a “covering piece”) that, when joined, collectively forms a contour over a person's face to ensure a fit to the user's facial structure. In some embodiments, the frame 110 can be implemented as a single unitary structure.

The respiratory protective device 102 includes a breathable filter 120 configured to filter particulates from the air. In some implementations, the breathable filter 120 is a replaceable filter with a pre-defined filtration configuration having a desired particulate filtration efficiency. In some implementations, the desired particulate filtration efficiency is 95% or greater (e.g., an N95 or P100 mask filtration). Other filter configurations may be used, e.g., N95, N99, N100, R95, R99, R100, P95, P99, P100, HE, among others described herein.

In the example shown in FIG. 1A, the frame 110 includes a number of cavities 109 (shown as 109a-109c) for a number of sensors 104 (e.g., 104a-104n). In some embodiments, the cavities 109 and sensors 104 may be disposed along the frame 110 at a position that corresponds to an infraorbitale facial region, a zygomatic facial region, or a region therebetween; a chin point facial region, a gonion facial region, or a region therebetween; or a menton facial region, a sagittal plane, or a region therebetween.

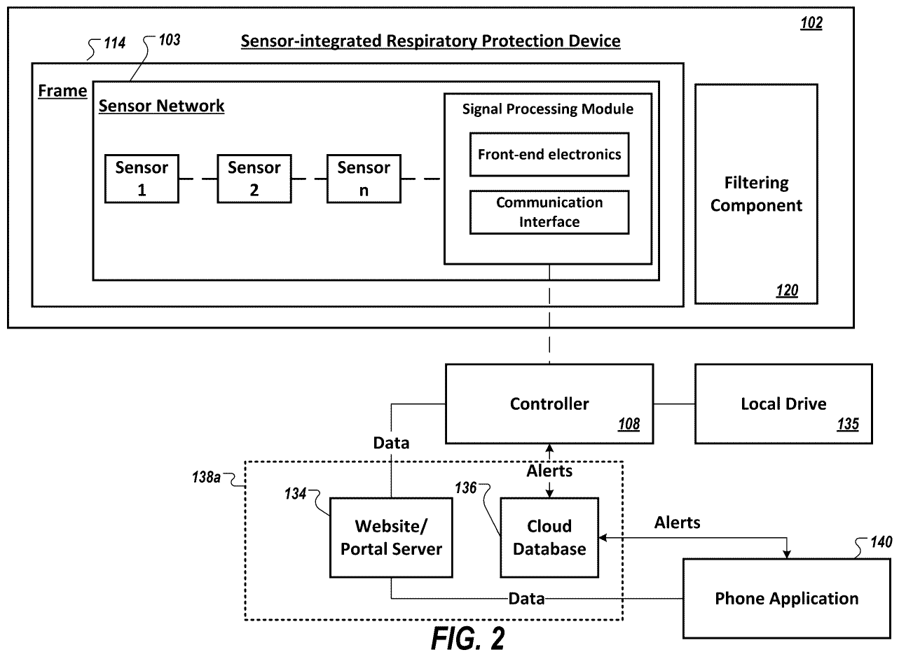

In some embodiments, the respiratory protective device 102 includes conduits 118 to house electrical connections (e.g., wiring) between the sensor network 103 and the controller 108 configured with a local datastore 135 (see FIG. 2) to store the measured signal. In other embodiments (not shown), the sensors may be connected by wireless connection or via surface conductive paint. In the example shown in FIG. 1A, each of the base frame 112 and the covering piece 114 form network channels (shown as 117a, 117b) to house the sensor network 103. In other implementations, a different number of sensors 104a-n are used (e.g., one or two sensors).

While in the example of FIG. 1A, the frame 110 includes both a first portion 112 and a second portion 114 adhered together, in other implementations, the frame can be made unitary. In some implementations, the sensors 104a-n can be made from woven or knitted conductive fabrics. In some implementations, the data buses 118 may be implemented using conductive yarns or printed using conductive material on PI/PET film or copper wire. In some implementations, the sensors 104a-n and data buses 118 can be printed using conductive materials on any substrate, such as polyimide (PI) film, polyethylene terephthalate (PET) film, polyacrylic acid (PAA), textile fabric, among others.

Retrofit Device. Referring to FIG. 1C, the respiratory protective device (RPD) 150 is an off-the-shelf respiratory device with a pre-defined filtration configuration having a desired particulate filtration efficiency. For example, the particulate filtration efficiency may be 95% or greater (e.g., an N95 or P100 mask filtration). The sensor network 103 shown in FIG. 1C may be implemented into the RPD 150 via a base structure disposed about the periphery of the RPD (e.g., a peripheral platform). For example, the peripheral platform may be separately produced and adhered to the sensor network so that the sensor network can be adhered to an off-the-shelf RPD (e.g., via adhesive). In other implementations, the RPD may be manufactured with a peripheral platform (e.g., a fabric wing or flap structure) so that the sensor network may be attached to the integrated peripheral platform.

In general, the sensor network 103 of the system 100c collects pressure data (e.g., analog signals) concerning the pressure at the faceseal of the RPD 150. The analog signals may be transmitted to a signal processor and transformed into digital signals (e.g., along individual data lines for each sensor 104n in the sensor network 103). A continuous fit monitoring (CFM) connector (e.g., a 6-pin connector) is disposed at the end of the sensor network's data lines (and power line). The CFM connector facilitates coupling to a signal processor (e.g., a printed circuit board with one or more processors). The CFM connector and the PCB may be disposed on a portion of the RPD 150 or separately connected to a different portion of the user. The PCB then transmits pressure data wirelessly (e.g., to a user's phone). As described below, the digital signals are processed and used to perform pressure data analysis, ultimately leading to a monitoring and alert system for a user of the RPD 150.

Data Collection and Signal Processing. In each of FIGS. 1A, 1B, and 1C, the signal processing module 106 is coupled to the sensor network 103 (e.g., via a multi-pin connector). The signal processing module may be disposed on or adjacent to the respective respiratory protective device 102 or 150. The signal processing module 106 includes front-end electronics 128 and a communication interface 130. The signal processing module 106 receives signals (e.g., analog pressure signals) from the sensor network 103 along the data bus 118 and performs an analog-to-digital conversion (ADC). For example, the front-end electronics 128 may receive the signals and perform the ADC.

The signal processing module 106 in systems 100a, 100b, and 100c are in wireless communication with a controller 108 (e.g., a single-board computer). The communication interface 130 relays signals to the controller 108. The wireless communication between the communication interface 130 and the controller 108 is accomplished by Bluetooth antenna. In other implementations, the communication may be accomplished by Wi-Fi or any other common wireless transmission means.

In the system 100a, the controller 108 processes the measured signals (i) to locally monitor for fit (i.e., that the measured signals are within the pre-defined thresholds or ranges) and (ii) to relay the signals to a monitoring interface device 126 (e.g., a smart device, a wearable technology, smart watch, or smart phone). When an alert is generated, the controller 108 may then provide the alerts to the monitoring interface device 126. The monitoring interface device 126 can then store the measured signals and provide an interface for a notification of the alert and for a query of historical data. The monitoring interface device 126 may also display or generate a notification through its audio device, vibratory, or haptic output.

In the system 100b of FIG. 1B, the continuous fit monitoring system 100b is configured as a cloud-networked device that interfaces with cloud infrastructure 138. The cloud infrastructure 138 can also receive and store the measured signals and/or provide curation capabilities for an interface for the notification of the alert and for the query of historical data.

The system 100c of FIG. 1C is shown with options for (i) a monitoring interface device 126 that can then store the measured signals and provide an interface for a notification of the alert and for a query of historical data, and (ii) a cloud infrastructure 138 that can also receive and store the measured signals and/or provide curation capabilities for an interface for the notification of the alert and for the query of historical data. One or both of the configurations may be implemented, depending on the application.

FIG. 2 is a diagram showing an example architecture of the cloud infrastructure 138 that can interface with the continuous fit monitoring system 100 (e.g., the system 100b or 100c of FIGS. 1B-1C, respectively) in accordance with an illustrative embodiment. In the example shown in FIG. 2, the cloud infrastructure 138 (shown as 138a) includes a web hosting capability 134 (shown as “Website/Portal Server” 134) and a cloud database 136. Each of the website/server 134 and the cloud database 136 can communicate with a monitoring interface device (e.g., a monitoring interface device 126 of FIG. 126, shown as “Phone Application”140).

### Example Method of Fit Monitoring

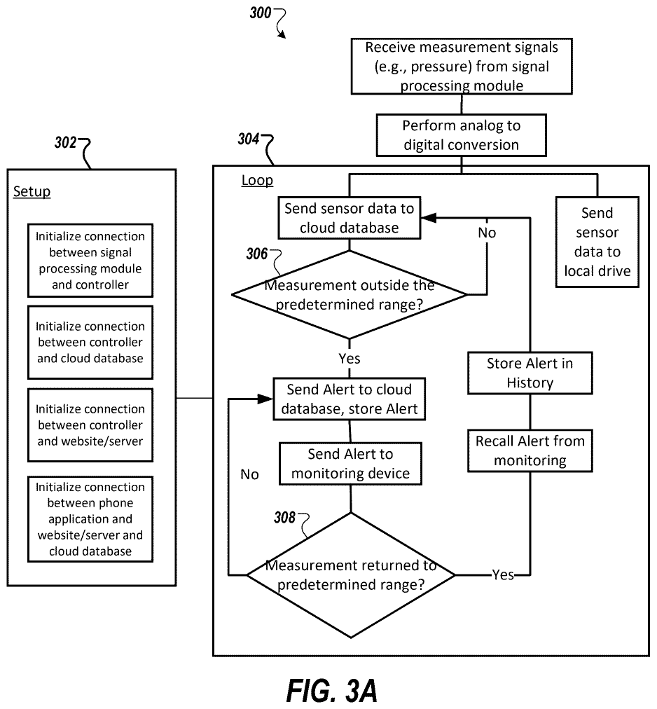

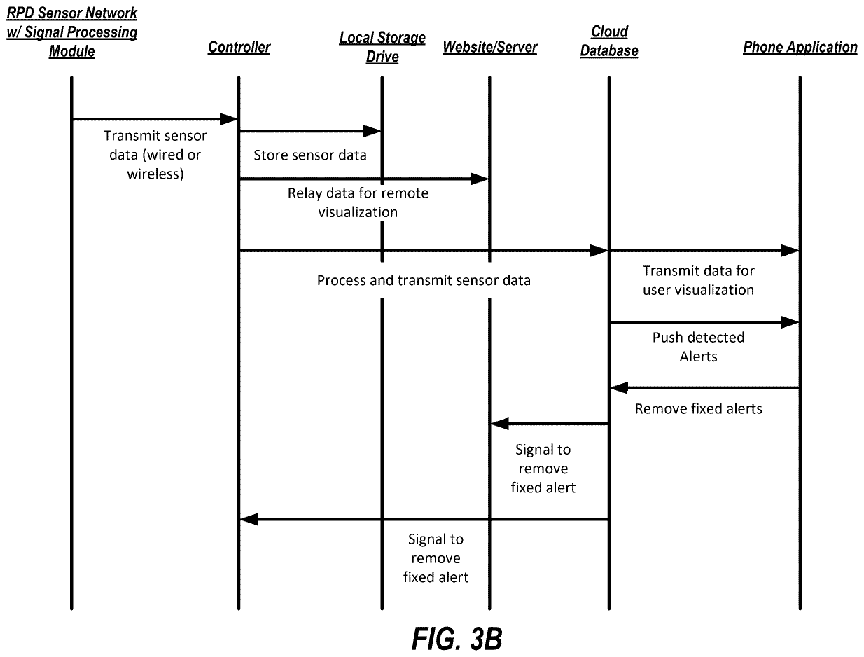

FIG. 3A is a flowchart depicting an example method 300 to continuously monitor the fit of a respiratory protective device (e.g., the RPD 150 of FIG. 1C, wherein reference numbers in this section may refer back to the system 100c of FIG. 1C). Method 300 includes a setup sequence 302 for the system to initialize connection between the signal processing module 106, the controller 108, the website/server 136, and the cloud infrastructure 138 (including the cloud database 136).

Method 300 includes the continuous fit monitoring loop 304. In the example shown in FIG. 3A, the continuous fit monitoring loop 304 is performed on measured data received from the signal processing module. The measured data is stored to a local drive and transmitted to a cloud database 136.

The cloud database 136 performs a first pressure check step 306. If the pressure remains within predetermined values, the loop continues, and sensor data continues to relay as normal. If the pressure values fall outside of a predetermined range (e.g., too low indicating a leak, or too high indicating the danger of pressure injuries to a user), then the cloud database 136 sends an alert signal to the monitoring interface device 126 (e.g., a phone application 140 shown in FIG. 2), notifying a user. A second pressure check step 308 is performed to determine if the user has adjusted the respiratory protective device 102 to fix the pressure issue. If the pressure has not returned to the predetermined range, a second alert may be sent or the initial alert is continued to be displayed. If the pressure has returned to the predetermined range, the cloud database 136 recalls the alert, stores the alert in history, and returns to normal sensor data gathering operation. In some implementations, the signal processing module 106 or controller 108 also relays signal data to a remote website/server 136 to enable remote monitoring of the respiratory protective device fit.

FIG. 3B is a flowchart depicting the back-end system of continuously monitoring the fit of the respiratory protective device (e.g., the RPD 150 of the system 100c of FIG. 1C). As shown, the respiratory protective device 150 with the signal processing module 106 transmits sensor data from the sensor network 103 to a controller 108. As shown in FIG. 2, the controller 108 stores data in a local drive, relays data to a website/server 136 for remote visualization, and transmits processed data to a cloud database 136. The cloud database 136 then interacts with the monitoring interface device 126 (e.g., a smart phone with a phone application 140), which can display data and/or alert a user.

When an alert is pushed to a user, the system 100b checks to see if the user has fixed the issue. Once fixed, the phone application 140 removes the alert, and the cloud database 136 relays the fixed alert information to the website/server 136 and the controller 108.

### Improved Sensing Devices, Systems, and Methods for Continuous Fit Monitoring

In a continuous fit monitoring (CFM) system for respiratory protective devices (RPD), such as a commercially available N95 filtering facepiece respirator (FFR), several key functions or unit operations are provided. For example, the CFM system—such as the system 100c of FIG. 1C—may (i) continuously monitor the pressure at a faceseal of the RPD; (ii) analyze pressure data to determine the potential for faceseal leakage, and (iii) notify a user to adjust the RPD and restore fit and/or prevent pressure injury. Then, the continuous fit monitoring system may cycle back to monitor the pressure at the faceseal. Each of these three exemplary steps may occur cyclically and continuously while the CFM system and the associated RPD are in use. Thus, the CFM system provides one or more users and/or a supervising system with consistent feedback on the status of one or more RPDs, enhancing safety and security for the users.

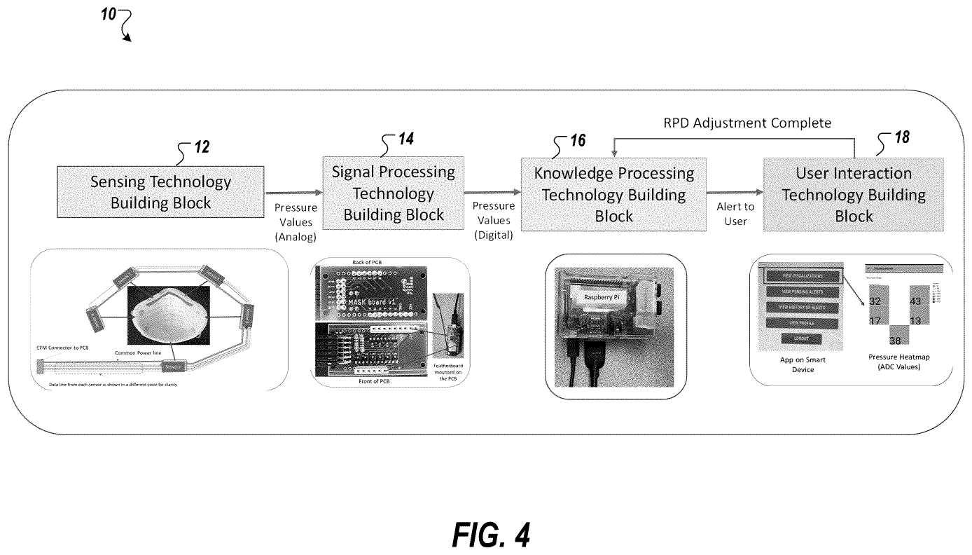

FIG. 4 shows a diagram of technology building blocks for example continuous fit monitoring (CFM) system 10. The system 10 of FIG. 4, and the technology blocks therein, may be described as an exemplary implementation of the system 100c of FIG. 1C, wherein each element of the system is described in further detail. Such details provide additional context on the structure of the sensor network for the RPD, the function of the sensor network, and the user experience as the CFM system monitors and notifies the user.

The diagram of the CFM system 10 includes a sensor technology block 12, a signal processing technology block 14, a knowledge processing technology block 16, and a user interaction technology block 18. In the sensor technology building block 12, a sensor network, such as a fabric-based sensor network, may be integrated into the respiratory protective device (RPD) to monitor the pressure at the faceseal (the interface between a user's face and the RPD). The sensor network may include one or more sensors disposed around the faceseal. Pressure data (e.g., analog signals) from the sensors of the sensor network may be transmitted to the signal processing technology block 14. In the signal processing technology block 14, the pressure data is transformed into digital signals and transmitted (e.g., wirelessly) to the knowledge processing technology block 16 for further analysis.

The sensor data is processed based on developed algorithms to detect the potential for a faceseal leakage when the pressure value[s] at the sensor[s] is lower than the threshold established for a proper fit. A “proper fit” of an RPD may be defined as a condition at which there is no faceseal leakage and the user is protected against inhalation hazards. The alert generated by the knowledge processing technology building block 16 is transmitted to the user interaction technology block 18, which may include an App running on a smartphone or tablet, that informs the user to adjust the RPD to prevent faceseal leakage. The pressure values are also displayed as a “heatmap” in the App and on the website. When the user adjusts the RPD and the pressure value returns to the baseline value at which the RPD fit is regained, the alert is removed from the App display, and stored in a Cloud database to maintain a history of alerts. The monitoring cycle continues.

Likewise, when the pressure values are higher than the threshold for proper fit, an alert is generated to inform the user to adjust the RPD to lower the pressure at the sensor[s] to prevent a pressure injury at the faceseal due to excess pressure caused by tightening the RPD more than is required to ensure a proper fit. Since the CFM is unobtrusive, it functions as a platform for data acquisition during the use of RPDs. The acquired data can be harnessed using machine-learning techniques to create a self-learning system. Thus, the continuous fit monitoring system protects the user of an RPD against inhalation hazards that could compromise their health and safety due to improper or loss of fit during RPD use.

### Fabric-Based Sensing and Method of Retrofittability

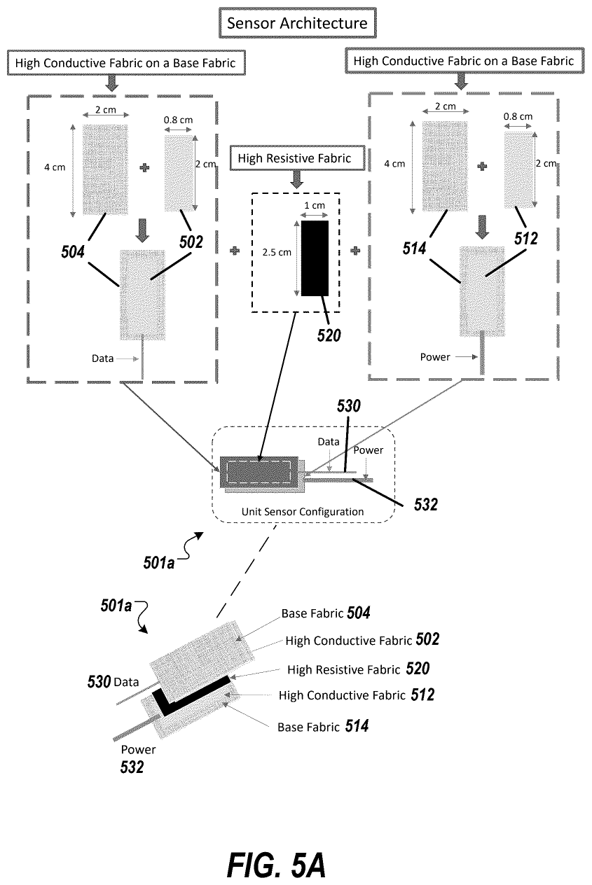

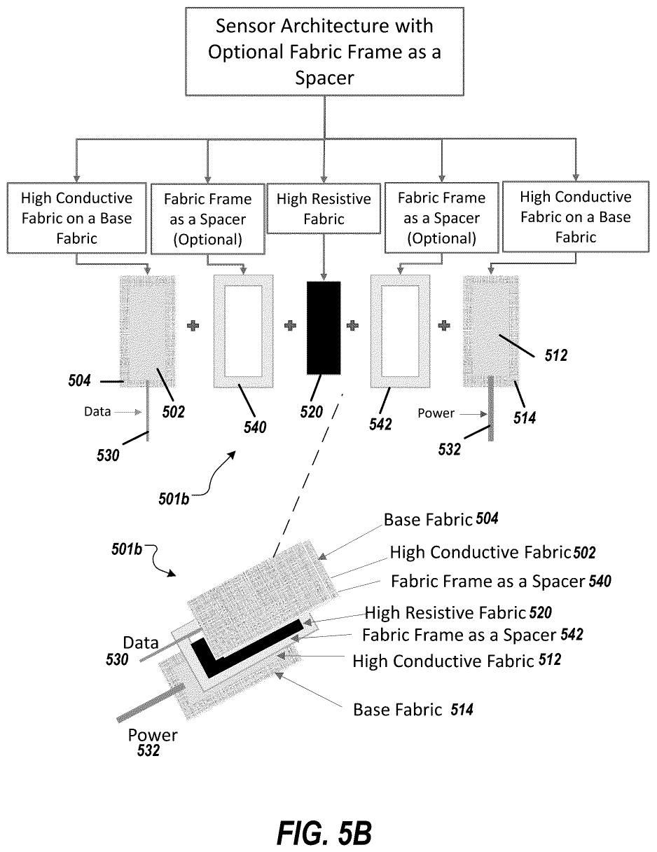

FIG. 5A shows a diagram of the sensor technology block 12 of FIG. 4. FIG. 5A shows the sensor architecture of a singular sensor in the sensor network, according to one example. The sensor 501a shown in FIG. 5A, which may be the same as one of the sensors 104n in the system 100c of FIG. 1C, is configured to monitor pressure at and around the faceseal of a user donning a respiratory protective device (RPD) adhered to the continuous fit monitoring (CFM) system. For example, the sensor network including the sensor 501a may be configured to adhere to an inner surface of an RPD adjacent to the periphery of the RPD, as further described below.

### Fabric-based Sensor

Each sensor in the disclosed sensor network is a fabric-based sensor, as described below. As opposed to rigid sensors, fabric-based sensors provide technical advantages in data collection and user experience. For example, rigid sensors often create discontinuities and pressure points, especially when used on a soft area of the skin (e.g., a user's face). These pressure points lead to inaccurate pressure data values. Furthermore, the pressure points are uncomfortable for the user, causing skin irritation and excess skin pressure. The fabric-based sensors bend and conform to a user's skin, reducing or eliminating the pressure points. Thus, the fabric-based sensors provide a more comfortable user experience, leading to more comfortable use of the RPD over time and less re-adjustments by the user. The continuous contact area between the user's skin and the fabric-based sensor (e.g., via a fabric or adhesive base material disposed therebetween for securement) also leads to more accurate data collection. Without the discontinuities of a rigid sensor, the pressure data more accurately reflects the contact between the RPD and the user's face.

The sensor 501a is a fabric-based sensor including a first conductive fabric layer 502 coupled to a first base layer 504 and a second conductive fabric layer 512 coupled to a second base layer 514. Each of the first base layer 504 and the second base layer 514 includes fabric material (e.g., non-conductive fabric comprising cotton or other common fibers). Each of the first conductive fabric layer 502 and the second conductive fabric layer 512 are coupled to their respective first and second base layers 504, 514 via adhesive, sewing, or bonding. When the sensor 501a is assembled, each of the first and second base layers 504, 514 are also coupled together via adhesive, sewing, or bonding. Each of the first conductive fabric layer 502 and the second conductive fabric layer 512 have a surface resistivity of less than 1 Ohm/cm².

The sensor 501a also includes a resistive fabric layer 520. When assembled, the resistive fabric layer 520 separates the first conductive fabric layer 502 from the second conductive fabric layer 512 (i.e., the resistive fabric layer 520 is the middle layer of the sensor 501a). When assembled, the first base layer 504 and the second base layer 514 form the outer layers of the sensor 501a. The resistive fabric layer has a surface resistivity of greater than 31,000 ohm/cm².

As shown, each of the first conductive fabric layer 502 and the second conductive fabric layer 512 has a rectangular shape with dimensions of 2 cm×4 cm. As shown, each of the first base layer 504 and the second base layer 514 have dimensions of 0.8 cm×2 cm. As shown, the resistive fabric layer 520 has dimensions of 1 cm×2.5 cm. However, it is understood that the dimensions shown in FIG. 5A are exemplary only and do not limit the disclosure. In other implementations, the sensor and its components are sized to fit on a portion of a respiratory protective device.

The sensor 501a further includes a data line 530 and a power line 532. The data line 530 is coupled to and extends from the first conductive fabric layer 502. The power line 532 is coupled to and extends from the second conductive fabric layer 512. Each of the data line 530 and the power line 532 are conductive yarns. The data line 530 may extend between the sensor 501a and a signal processing module, wherein the data line 530 relays data (e.g., pressure and/or proximity data) from the sensor 501a to the signal processing module. The power line 532 may extend between the sensor 501a and a power source (e.g., on the signal processing module). The power line 532 may also extend between multiple sensors of the sensor network, supplying power to each of the sensors in the sensor network.

FIG. 5B shows another implementation of a sensor, shown as sensor 501b, which is substantially similar to the sensor 501a of FIG. 5A except as described below. The sensor 501b includes a first spacer 540 and a second spacer 542. The first and second spacers 540, 542 have a rectangular-ring shape substantially matching that of the space between the first conductive fabric layer 502 and the first base layer 504. The first and second spacers 540, 542 are disposed between the resistive fabric layer 520 and each of the first conductive fabric layer 502 and the second conductive fabric layer 512, leaving a space for the resistive fabric layer 520 in the middle. The first and second spacers 540, 542 enhance the structural integrity of the sensor 501b. The first and second spacers 540, 542 include a textile fabric material (e.g., made of cotton or other fibers).

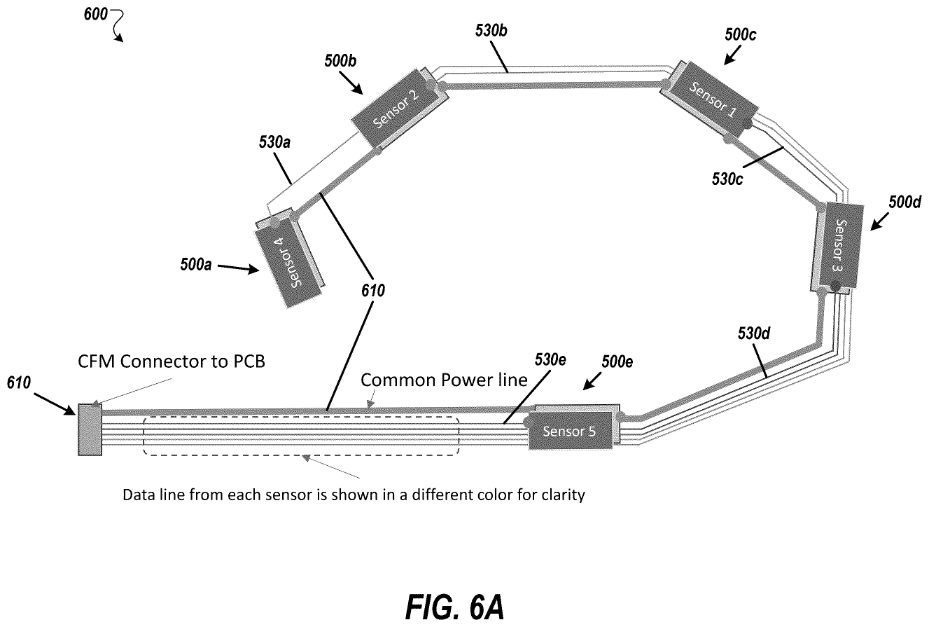

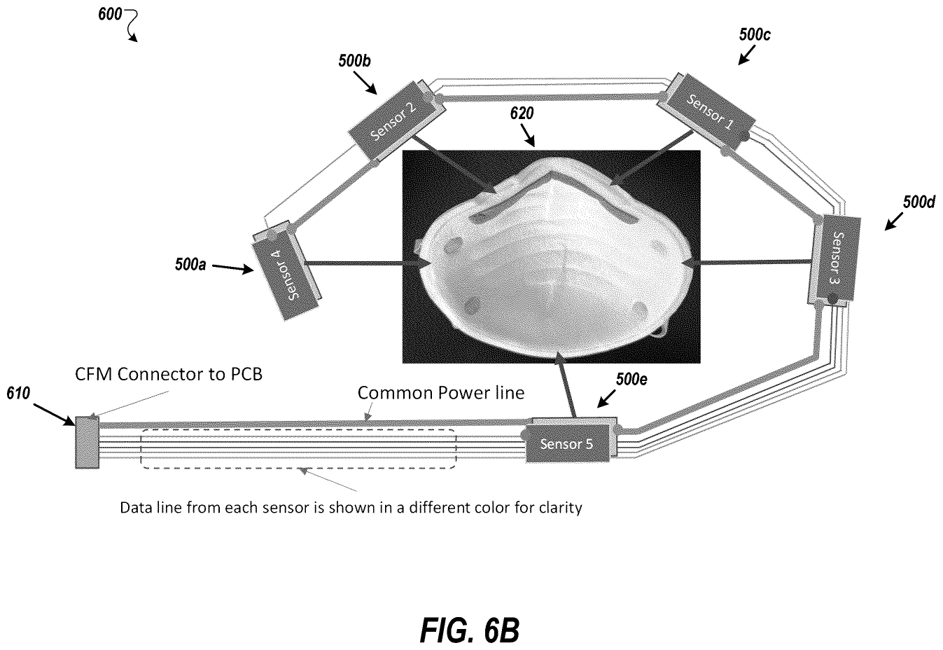

FIG. 6A shows a sensor network 600 including a plurality of sensors 500, which may be the same as (i) sensors 104a-n of FIGS. 1A-1C, or (ii) sensors 501, 501b of FIGS. 5A-5b. The five sensors 500 of the sensor network 600 in FIG. 6A are shown as sensors 500a-500e. Each of the sensors 500a-500e is connected to a CFM connector 610. For example, the CFM connector 610 is a six-pin continuous fit monitoring (CFM) connector configured to attach and/or communicate with a portion of the signal processing technology block 14.

Each sensor 500a-500e includes its own data line 530a-530e that extends between the respective sensor 500a-500e and the CFM connector 610. Thus, data from each sensor 500a-500e is individually communicated through the CFM connector 610 to a portion of the signal processing technology block 14 (e.g., a printed circuit board) where the data can be compiled and interpreted. A single power line 532 extends between the CFM connector 610 and each sensor 500a-500e.

FIG. 6B shows a diagram of the sensor network 600 along with a respiratory protective device (RPD) 620 (e.g., similar to the RPD 150 in FIG. 1A). The diagram of FIG. 6B shows example locations where the sensors 500a-500e may be adhered to the RPD 620. The fabric-based sensors provide a shape-conformable, continuous surface for more accurate data collection and improved user comfort. In some implementations, as shown in FIG. 5B, the sensor may include a fabric frame for improved structural integrity. The fabric-based sensors additionally provide for a continuous and compliant surface the existing, rigid sensors do not. Existing sensors introduce undesirable shear stresses at the point of contact that can lead to facial injury, particularly from repeated and/or prolonged use. The fabric-based sensors of the present disclosure solve these problems, providing a comfortable and accurate surface for data collection. As will be further described below, the structure of the RPD and the sensor network and the attachment mechanism between the two components-may have a variety of implementations and combinations.

### Continuous Fit Monitoring System Architecture

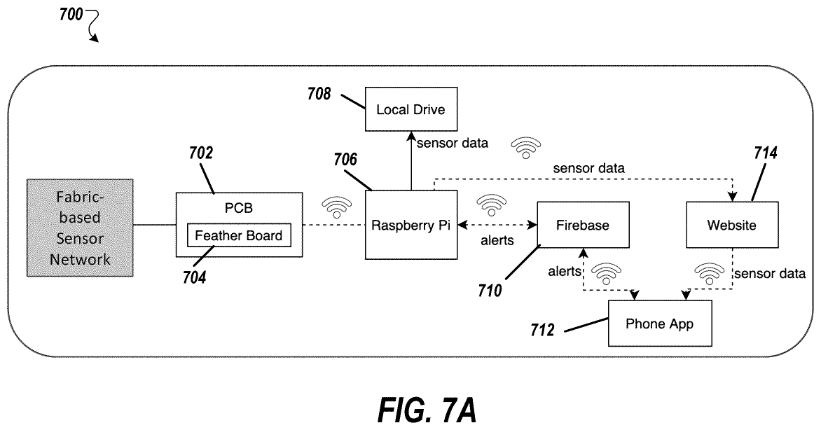

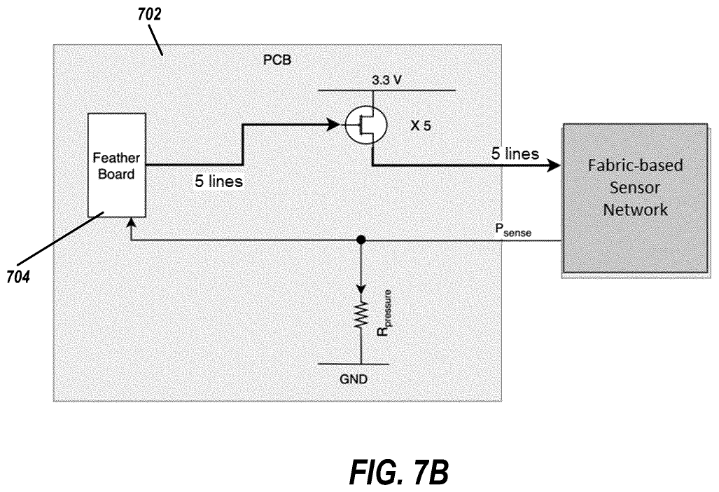

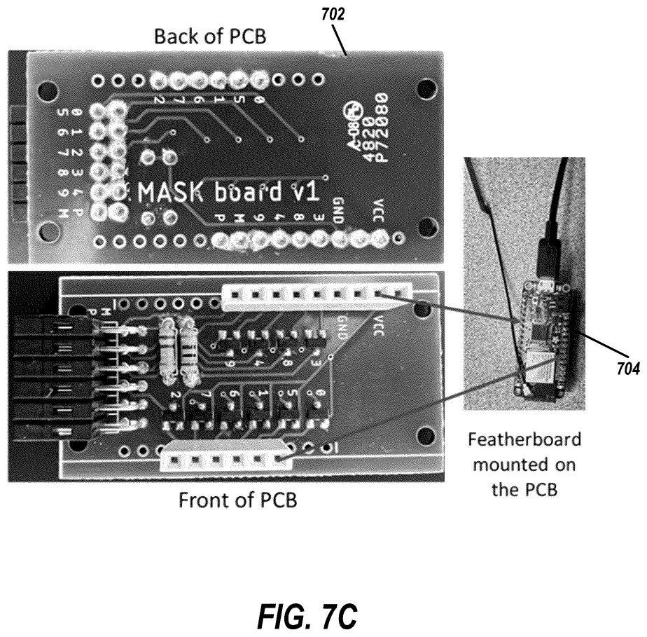

FIG. 7A shows a diagram of the components in a continuous fit monitoring system (e.g., the system 10 as shown in FIG. 4 and/or a combination of elements in the system 100c of FIG. 1C). The CFM system 700 shown in FIG. 7A includes the fabric-based sensor network 600 (e.g., including the sensors 500a-500e), a printed circuit board (PCB) 702, a controller 706 (e.g., a Raspberry Pi), a local drive 708, a platform 710 (e.g., a mobile and web application, such as Firebase), a phone App 712, and a website 714.

The sensors 500a-500e of the sensor network 600 monitor pressure and/or proximity at the faceseal of the filtering facepiece respirator (FFR). The pressure and/or proximity data is transmitted to the signal processing technology block 14 through the sensor network's CFM connector 610.

The signal processing technology block 14 includes a fabricated printed circuit board (PCB) 702 that digitizes the analog signals. The signal processing technology block 14 further includes a processing unit 704 (e.g., a Featherboard such as an AdafruitFeather MO) that is plugged into the PCB 702. The six-pin CFM connector 610 is connected to the pin connector on the PCB 702. The processing unit 704 is responsible for receiving commands from the controller 706 and sending analog to digital convertor (ADC) data to the controller via a common WiFi network.

The processing unit 704 transmits the pressure and/or proximity data wirelessly to the knowledge processing technology block 16, which includes the controller 706 and the computer-readable instructions (e.g., algorithmic-based instructions) developed to predict the potential for faceseal leakage. The controller 706 analyzes the pressure values from the sensor network 600 to generate “alerts” when the FFR is no longer fitting the user (e.g., due to faceseal leakage) based on a set of baseline thresholds of pressure values. In practice, the baseline pressure values may be set during a first quantitative fit testing (QNFT), which may implement Occupational Safety and Health Administration (OSHA) protocol 29 CFR 1910.134 when the FFR is issued to the user.

The Alerts are sent to the platform 710 (e.g., a mobile and/or web application platform, such as Firebase). The Alerts are then communicated from the platform 710 the phone App 712 running on the user interaction technology block 18. The user interaction technology block 18 includes a smartphone, tablet, or other user device. Once the Alert is sent to the phone App 712 on the user's device, the Alert is communicated to the user in the form of a sound, a vibration, an image, a changing display, or a combination of the above. The user device will additionally indicate which sensors 500a-500e in the sensor network 600 are likely to cause (or are currently experiencing) faceseal leakage and require adjustment. The pressure data from the sensor network 600 may also be displayed (e.g. in a heatmap shown in the phone App 712).

After prompting via the Alert, a user may adjust the RPD. When the user adjusts the RPD, and the pressure value at the specific sensor[s] 500a-500e returns to the baseline value, the Alert disappears from the phone App 712 and is stored in the history of Alerts on the platform 710. The controller 706 saves the sensor data on the local drive, which can be the controller 706's internal storage or external storage such as a USB drive. The pressure data is also sent to website 714 where the heatmap can be visualized by logging in to the website. This feature will be useful when users are operating in high-risk environments (e.g., a building fire) and their safety can be monitored by others accessing the data on the website 714. As shown in the diagram in FIG. 7A, the sensor data is sent to the website 714 directly. The phone App 712 accesses the sensor data from the website 714. Alternatively, the sensor data can be sent directly to the phone App 712 for displaying the pressure heatmap.

The platform 710 can store information about the CFM system, for example, active Alerts, saved Alerts, confirmed Alerts, and user information. As the names imply, active Alerts are those that need to be addressed by the user by adjusting the RPD to avoid faceseal leakage. Saved Alerts is the history of alerts generated (whether addressed or not). Confirmed Alerts are those that have been corrected by the user by adjusting the RPD. This history of alerts can be accessed later for data mining and machine learning to enhance the algorithms to assess the potential for a faceseal leakage. The user information may include the name, login ID, and other personal information about the user.

FIG. 7B shows a diagram of the PCB 702 including the processing unit 704. Additionally, FIG. 7C shows an image of the signal processing technology block 14 with PCB 702 and the processing unit 704 plugged into the PCB 702. The processing unit 704 provides power to the PCB 702 and controls the five P-channel MOSFETs via five conductors (shown as “5 lines”) as shown in FIG. 7B. Each sensor is individually connected to the PCB as their own respective circuit. In one implementation, the PCB 702 is designed to host ten P-channel MOSFETs, which could support up to ten sensors connected to the PCB 702. The PCB 702 also has two different data line ports connecting to two different pull-down resistors and two ADC ports. The PCB architecture also allows the use of different types of sensor networks, e.g., a pressure sensor network and a moisture sensor network that can be connected to the PCB 702. With a total of ten MOSFETs on the PCB 702 in some implementations, the total number of sensors (of one or two types) cannot exceed ten. However, in other implementations, more than ten sensors may be used with the PCB.

### Structural Integration of the Sensor Network with the Respiratory Protective Device

Various implementations and designs of sensor-integrated RPDs are shown and described in this disclosure. For example, a sensor network may be implemented into or attached to an existing, off-the-shelf filtering facepiece respirator (e.g., an N95 respirator). In particular, two strategies for implementing the sensor network into the FFR are shown in the following figures and description—a modular system, and an integrated system.

In a modular system, the sensor network is placed on a stand-alone peripheral platform that can be attached to the FFR (e.g., via adhesive) or otherwise embedded and secured onto an RPD. For example, the adhesive type may facilitate removing the peripheral platform and/or the sensor network from the FFR and re-attaching the peripheral platform and/or the sensor network to another FFR. The sensor network may be adhered (e.g., via silicone scar tape or other adhesive materials) to the portion of the FFR that forms the faceseal, which may be referred to as a “periphery” or a “peripheral portion” of the respirator. As such, the base structure of the sensor network on which the sensors are adhered may be referred to as a “peripheral platform.”

Prior to disposal of the FFR, the sensor network can be removed from the FFR peripheral platform, decontaminated, and rendered ready for securing to another FFR. For a modular system, the peripheral platform may be produced/manufactured separately from the FFR itself. Thus, the existing FFR manufacturing process and supply chains need not be altered to provide a CFM system as described herein. Instead, in some implementations, a sensor network may be separately produced and then assembled into an existing, off-the-shelf filtering facepiece respirator. Such an implementation allows users (e.g., hospital systems) to continue ordering a particular respirator with the added benefit of the attachable sensor network retrofitted into the respirator. Therefore, the continuous fit monitoring system and its advantages may be seamlessly implemented into the existing respirator framework

In an integrated system, the peripheral platform is bonded to the FFR when it is manufactured. For example, the peripheral platform structure may be bonded or formed with the FFR during the standard manufacturing process for an FFR. Notably, the sensor network may be separately produced and later adhered to the integrally formed peripheral platform. Such a modification may be minor for existing FFR manufacturing processes, and it allows for the sensor network to be produced in a stand-alone manner as needed. Given the number of respiratory protective devices (e.g., N95 respirators) available in the marketplace, the exemplary system and method provides for the instrumentation and monitoring of anyone of them in a straightforward and robust manner. Following the use of the FFR and prior to its disposal, the sensor network may be additionally removed/detached from the FFR, decontaminated, and rendered ready for re-use by being secured into another FFR with a peripheral platform.

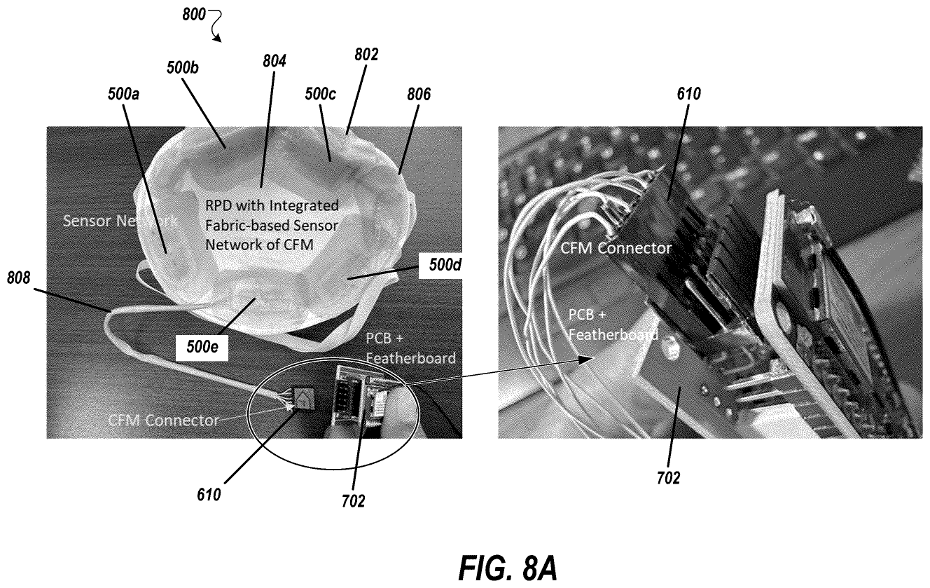

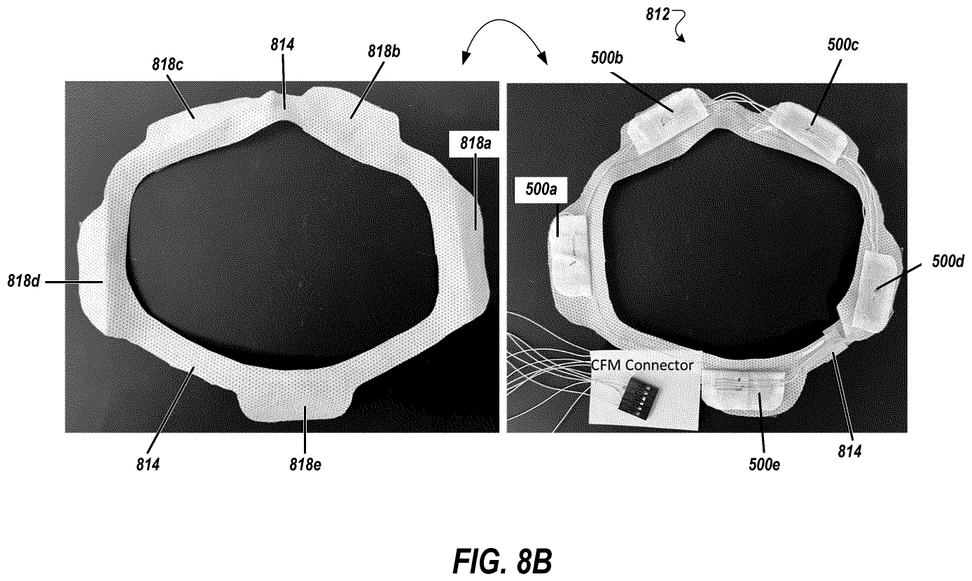

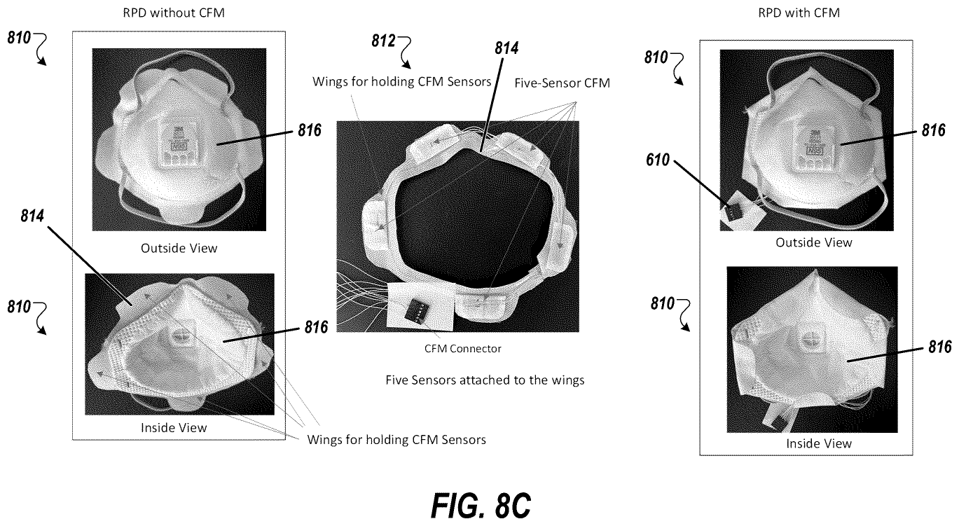

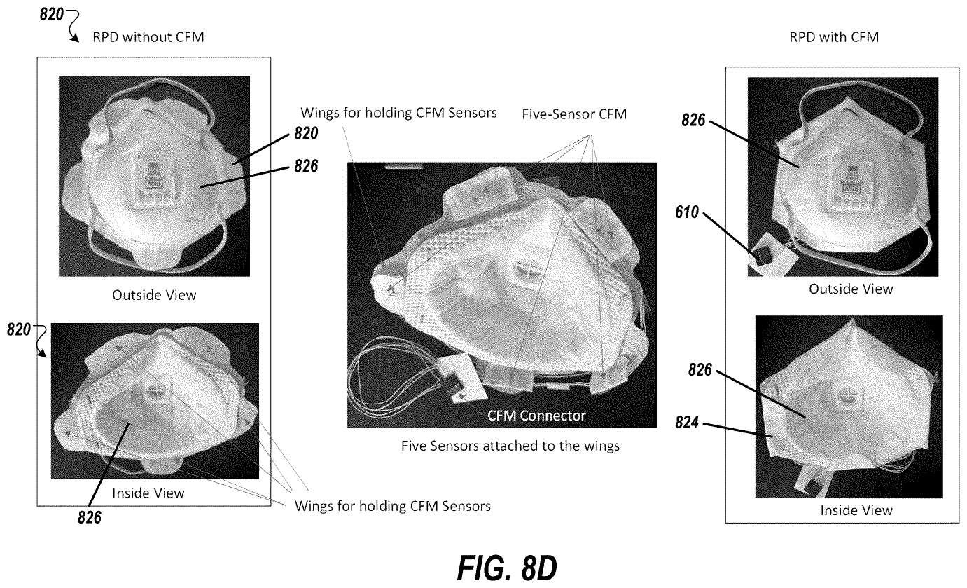

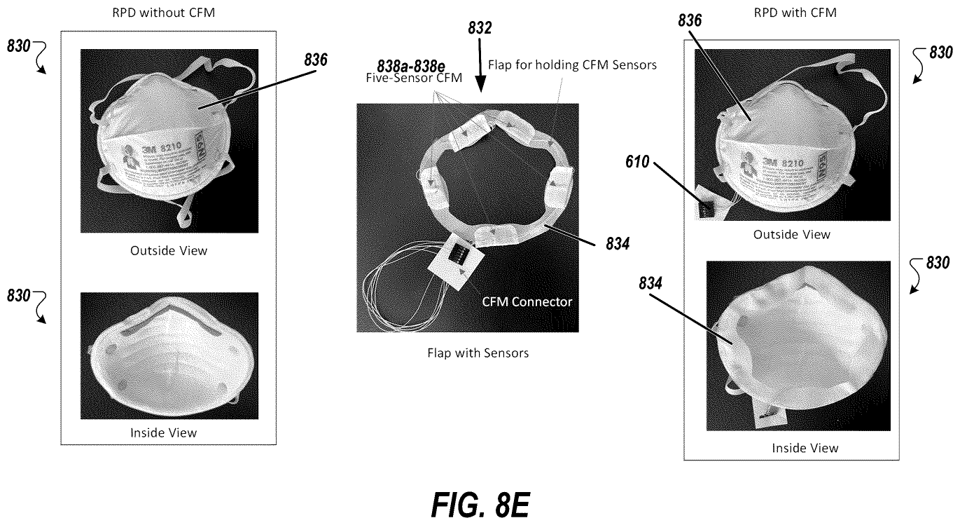

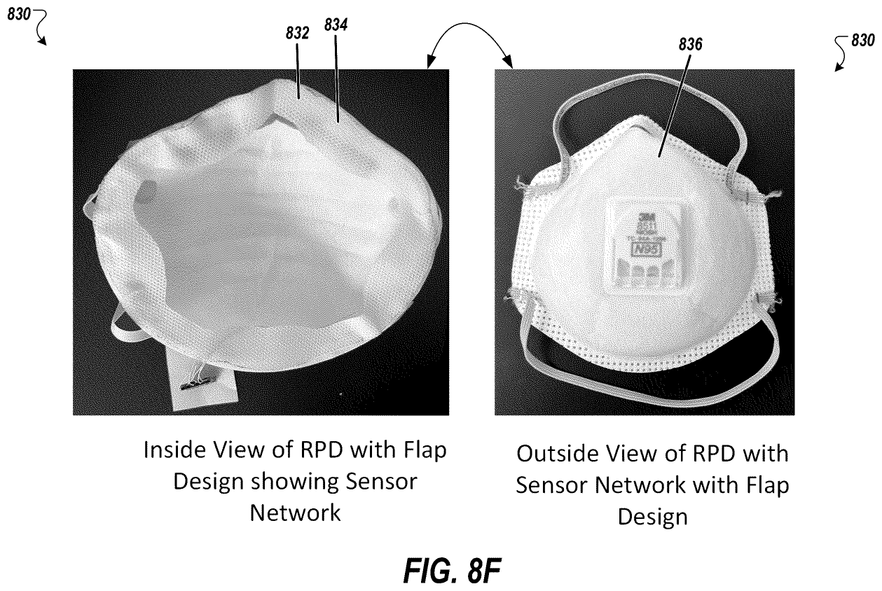

FIG. 8A shows a first implementation of a respiratory protective device (RPD) 800 including a modular sensor network (e.g., similar to the sensor network 600). The RPD 800 includes a filtering facepiece respirator (FFR) 802 (e.g., an N95 respirator) having an outer surface, an inner surface 804 opposite the outer surface, and a periphery 806. The periphery 806 may be defined as a region of the inner surface 804 adjacent to the outer surface. The periphery 806 may further be defined as a circumferential area of the inner surface 804 configured to contact a facial region of a user (e.g., the faceseal).

As shown in FIG. 8A, the sensor network 600 and the sensors 500a-500e thereof are adhered to the inner surface 804 of the FFR 802. Specifically, each of the sensors 500a-500e are adhered to a different portion of the inner surface 804 about the periphery 806. Each of the sensors 500a-500e are adhered to the inner surface 804 of the FFR 802 via adhesive in the form of patches of scar tape 808a-808e. Each patch of scar tape 808a-808e covers a respective sensor 500a-500e and secures the sensor 500a-500e to a portion of the FFR 802 (e.g., about the periphery 806 of the inner surface 804). Thus, the user's face does not directly contact the sensors 500a-500e. In certain implementations, the scar tape can be used continuously throughout the periphery to adhere the sensor network to the respiratory protective device.

The RPD 800 further includes a connection 808 which includes the data line 530 and the power line 532 (e.g., as shown in FIG. 6B) of the sensor network 600. The RPD 800 further includes the CFM connector 610 disposed on one end of the connection 808 to provide a connection between the sensors 500a-500e. The RPD further includes a PCB 702 having a processing unit 704. FIG. 8A shows a disconnected state of the PCB 702 and the CFM connector 610 and a detailed view of the connected state of the PCB 702 and the CFM connector 610.

FIGS. 8B-8C show another implementation of a peripheral platform 812 for a respiratory protective device (RPD). Specifically, FIG. 8B shows the stand-alone peripheral platform 812 with wings on the left and the peripheral platform 812 with the sensor network integrated on the peripheral platform 812 on the right. FIG. 8C shows a diagram of a RPD 810 without and with the continuous fit monitoring sensor network integrated into the peripheral platform 812.

The peripheral platform 812 for securing the sensor network includes five sensors 500a-500e, similar to the above-described implementations. The peripheral platform 812 includes a base structure 814 (e.g., a fabric structure) having a shape matching the periphery of the FFR 816 of the RPD 810. The base structure 814 includes five wing-like protrusions that define sensor adhering portions 818a-818e. Each sensor 500a-500e is adhered to a respective adhering portion 818a-818e of the base structure 814 (e.g., via adhesive, sewing, or bonding). Each of the data lines and the power line of the sensor network is fed around the base structure 814 and out to the CFM connector 610.

Although the sensor network includes five sensors 500a-500, and the peripheral platform 812 includes five adhering portions 818a-818e, in other implementations the systems, devices, and methods disclosed herein may provide a different number of sensors. In some implementations, the number of sensors may be in the range of 1 sensor to 50 sensors (e.g., 1, 2, 3, 4, 5, 6, 7, 8, 9, 10, 15, 20, 25, 30, 35, 40, 45, or 50 sensors). Correspondingly, the peripheral platform may include a number of adhering portions in the range of 1 adhering portion to 50 adhering portions (e.g., 1, 2, 3, 4, 5, 6, 7, 8, 9, 10, 15, 20, 25, 30, 35, 40, 45, or 50 adhering portions). In some implementations, the sensor is a continuous band extending around the periphery of the FFR (e.g., along the entire faceseal).

As shown in FIG. 8C, the base structure 814 of the peripheral platform 812, including the sensors 500a-500e, may be adhered to the FFR 816. For example, the base structure 814 is adhered to the periphery of the FFR 816 such that each of the wing-like adhering portions 818a-818e extends radially outward from the periphery in a first configuration (e.g., left panels of FIG. 8C). Then, when in use, each of the wing-like adhering portions 818a-818e is moved into a second configuration that is ready for use. In the second configuration, the wing-like adhering portions 818a-818e are flipped radially inward with respect to the periphery such that the sensors 500a-500e are placed to engage with a facial portion of a user (e.g., in the right panels of FIG. 8C).

The RPD 810 and the peripheral platform 812 shown in FIGS. 8B-8C represents one of the stand-alone implementations of the retrofitted respiratory protective devices of the present disclosure. For example, the peripheral platform 812, including the sensor network therein, may be produced and then separately adhered to an off-the-shelf respirator (e.g., an N95 respirator). The system is easy to attach to existing respirators (e.g., with adhesive), and can quickly be adopted by users in their normal environment (e.g., healthcare professionals in a hospital). Such a system enhances the safety and confidence that users have in their RPD. For example, users can be confident that their faceseal is providing adequate pressure, and that they will be alerted if the pressure changes outside of a predetermined window of pressure values.

FIG. 8D shows another implementation of an RPD 820 including a FFR 826, which represents the integrated system of the RPD. For example, a peripheral platform 824 of the RPD 820 is similar in shape to the peripheral platform 814 of the RPD 810. For example, wings are disposed around the peripheral platform 824, providing a space for the adherence of a sensor in a sensor network. However, the peripheral platform 824 is bonded to the FFR 826 (e.g., at manufacturing). For example, the materials used in the production of the FFR 826 may further include the production of the peripheral platform 824. Thus, a space is provided for the sensors in the sensor network. The sensor network (500a-500e) is then adhered to this peripheral platform 824 and secured to be ready for use. In this implementation, the sensors 500a-500e in the sensor network may be decontaminated and reused, while the FFR 826 and peripheral platform 824 device may be disposed after use.

FIGS. 8E-8F show another implementation of a respiratory protective device (RPD) 830 including a peripheral platform 832 configured to secure a sensor network. Specifically, FIG. 8E shows a diagram of the RPD 830 without (left) and with (right) the continuous fit monitoring system secured within the peripheral platform 832. FIG. 8F shows the front and back sides of the FFR 836 with the peripheral platform 832.

The peripheral sensor network platform 832 includes a space configured to couple or secure five sensors 500a-500e, similar to the above-described implementations. The peripheral sensor network platform 832 includes a base structure 834 (e.g., a fabric structure) having a shape matching the periphery of the FFR 836 of the RPD 830. However, in contrast to the wing-like design of the peripheral platform 814 of FIGS. 8B-8C, the peripheral platform 832 includes flaps. Each of the flaps 838a-838e are formed to couple and secure a respective sensor 500a-500e (e.g., via adhesive, sewing, or bonding). Each of the data lines and the power line of the sensor network are fed around the base structure 834 of the peripheral platform 832 and out to the CFM connector 610. The base structure 834 thus forms a flap-like periphery around the FFR 836 which houses the sensors 500a-500e in a position configured to engage with a facial region of a user.

Similar to the modular and integrated options for the above-described peripheral platforms, the flap version of the peripheral platform may be part of a modular or integrated system. For example, in the central panel of FIG. 8E, the flap-like peripheral platform is shown as a separately attachable portion with the sensor network and CFM connector already in place. Furthermore, a flap-like peripheral platform integrated into a respirator is shown in FIG. 8F wherein the separate sensor network has been adhered to the integrated peripheral platform. In other implementations (not shown), the sensor network may be integrated into the peripheral platform of an integrated respirator altogether (e.g., in a single device).

### Example Monitoring Application—User Interaction Technology Building Block

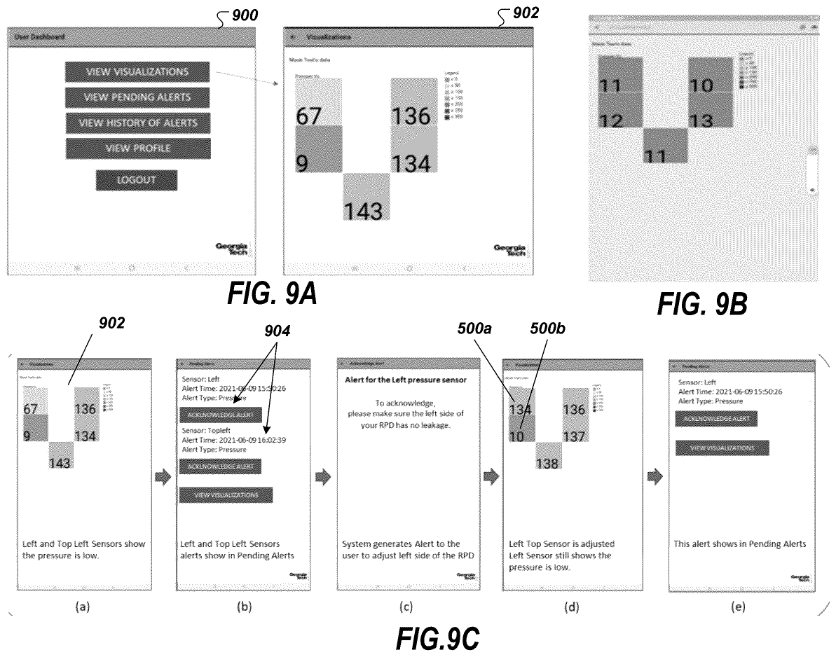

FIG. 9A shows the user dashboard 900 in the phone App 712 running on an Android tablet along with the visualization of the pressure heat map 902. The menu options shown on the left in the dashboard include View Visualizations, View Pending Alerts, View History of Alerts, View Profile, and Logout. The View Visualizations option displays the color-coded pressure heat 902 maps to reflect the magnitude of the pressure under each sensor 500a-500n (e.g., of the sensor network shown in FIG. 6B, or in any of the sensor-integrated RPDs in FIGS. 8A-8E). The color thresholds for the heat map 902 can be configured in the App to suit the requirements. In the figure, the ADC (analog to digital converter) values are displayed. When the option to display the pressure in psi is chosen in the phone App 712, the pressure will be displayed in lb/in².

When the faceseal pressure falls below a certain threshold under one of the sensors 500a-500n, an alert is sent to the user's phone App 712 with a message to adjust/tighten the respiratory protective device. Those alerts are stored under “Pending Alerts” implying that the potential for a faceseal leakage is high unless the user corrects the position of the respiratory protective device. When the user adjusts the respiratory protective device, the system detects the change in pressure. If it meets the defined threshold, the alert is removed from Pending Alerts and stored in “History of Alerts.” These alerts can be analyzed at a later date to understand the performance of respiratory protective devices over time and to spot any specific trends or activities during use that lead to faceseal leakage. This type of data analytics, facilitated by the unobtrusive means to monitor pressure data in real-time, will be valuable in enhancing the design of respiratory protective devices (RPDs). The “User Profile” option in the menu is used to enter information about the user, which can then be correlated with other data to enhance the personalization of the device.

FIG. 9C shows an example sequence of operations during the typical use of the respiratory protective device with continuous fit monitoring. When the user chooses the “View Visualizations” option in the main menu, the pressure heat map 902 is displayed as shown in FIG. 9C (panel a). Since the top-left and left sensors 500a, 500b are below the threshold value set in the phone App 712, it generates two alerts to the user indicating areas of potential faceseal leakage. When the “View Pending Alerts” option is chosen, the two alerts 904 are displayed as in FIG. 9C (panel b). FIG. 9C (panel c) shows an alert to the user. The alert may include suggestions (static text or dynamically generated output based on the sensor reading) to adjust the respiratory protective device. When the user adjusts the respiratory protective device, the pressure in the top left sensor 500a goes above the set threshold, as shown in FIG. 9C (panel d), and that alert is moved to “History of Alerts.” However, the user has not adjusted the respiratory protective device in the area under the left sensor 500b; therefore, the alert for the left sensor 500b remains as shown in Pending Alerts in FIG. 9C (panel e).

All the pressure values, alerts, and actions are stored in the database and can be retrieved for carrying out data analytics to understand the performance of the respiratory protective device over time. The data can also be used to identify the potential for a pressure injury from donning the respiratory protective device for long periods of time and alerting the user to prevent a pressure injury. In short, the respiratory protective device with the continuous fit monitoring system can become an unobtrusive data acquisition platform for research and development of respiratory protective devices, including human factors associated with the use of respiratory protective devices both in real-time and over time in workplaces with inhalation hazards.

FIG. 9B shows the ADC values displayed in App 720, which correspond to the pressures in the five sensors 500a-500e prior to donning by the subject. Since the pressure at the faceseal measured in psi will be low, we use ADC values to demonstrate the responsiveness of the sensor network to small changes in pressure with facial movement.

A study was conducted wherein the effect of changes in facial profile was tested from natural to talking to smiling and to yawning-on the pressure distribution in the faceseal on human subject. In the subject's natural state, the pressure in the chin sensor is greater when compared to data prior to donning. In the talking state, the pressure is higher in all the sensors. In the smiling state, there is a change in the pressure values from the talking state, albeit by a small amount. In the yawning state, the pressure has increased significantly in the chin sensor. In the experimental testing and discussion that follows, examples of such facial changes and their effect on the sensor network and alert system are shown and described. In general, the disclosed CFM system provides updated real-time information to a user about their FFR faceseal, giving them confidence in their respirator and ensuring their safety during use.

### Experimental Testing and Evaluation of Example Embodiment

### Discussion

The protection of healthcare workers is a national imperative, and personal protective equipment (PPE) is their last line of defense in the NIOSH Hierarchy of Controls [1]. The COVID-19 pandemic reinforced the importance of PPE, especially filtering facepiece respirators or FFRs (e.g., N95), for healthcare workers on the front lines. The effectiveness of protection offered by a respiratory protective device (RPD) against an inhalation hazard for a user is a function of the: efficacy of the device, compliance with its use, and a commitment by manufacturers to produce the needed products, including pathways or means to make it available for the user to access the right type of device at the right time [2].

A well-known example of an RPD is an N95 Filtering Facepiece Respirator (FFR), which is certified by NIOSH to have 95% filtration efficiency. Commonly referred to as an N95 respirator, the FFR is used by healthcare professionals for protection against infectious inhalation hazards in the workplace. The onus to ensure the effectiveness of protection offered by the FFR falls on the user for the following reasons: The user must undergo an annual OSHA-mandated fit-test to ensure that the FFR will fit snugly on the face to ensure their safety. The user must don the FFR correctly every time and perform a “user seal check”—a subjective assessment—to ensure that it fits correctly and that there is no faceseal leakage, i.e., at the interface between the face and the FFR. If there is a physical change in the user's facial profile between annual fit tests (e.g., loss or gain of weight), the user must ensure that the existing FFR fits them properly or seek out a new one and pass a fit test. If the FFR is worn too “tightly,” the user will be uncomfortable, or worse yet, develop pressure injuries at the faceseal as was experienced by many health care professionals during COVID-19.

The pressure exerted by the FFR on the face at the interface affects both the comfort of the wearer and the leakage at the interface, which is the faceseal. Roberge et al. studied the importance of tethering devices that hold an FFR on the face during repeated doffing and donning [3]. They found “a progressive decline in the loads generated by the top and bottom tethering devices of the three models of N95 FFR tested over the course of multiple simulated donning, doffing, and wear periods in a 2.5-hr span.” This change in load (and hence, pressure) on the faceseal could alter the “fit” of the RPD, leading to leakages and thereby compromising the degree of rated protection from the device. Studies have also shown that the pressure exerted by the tethering devices is inversely proportional to the contact surface areas of the faceseal [4].

The pressure exerted by the RPD on the faceseal influences the comfort and tolerability of the user; it is one of the reasons for the discontinuation of the use of an RPD in a healthcare setting [5]. Currently, for FFRs, there is no routine “quantitative” metric or indicator that users can rely upon to know that the device has been donned correctly to ensure proper fit so that they will be protected while being comfortable. That “sense of security” for healthcare professionals is a critical factor in enabling them to perform at their best under trying circumstances (e.g., during COVID-19) without being afraid of compromising their personal safety. The ability to “calibrate” the fit with the measured pressure at the faceseal is also likely to lead to increased compliance with the correct use of the device contributing to enhanced effectiveness. During the initial fit test with such a device, quantitative baseline parameters can be established. Any change in these values during use that compromises the fit of the FFR would trigger appropriate alerts, prompting the user to adjust the device to prevent leakage. This feature will overcome one of the key challenges with the “user seal check,” which has been shown to not be a reliable substitute for quantitative fit testing when using FFRs [6].

Pressure Injuries from Respirators: The fit of the FFR, especially over long durations of wear, is another important factor. A tight-fitting respirator used continuously over long durations may cause skin irritation, injury, and pain [7]. Therefore, continuous monitoring of faceseal pressure can also provide information to the user to prevent pressure injuries associated with long-term use of respirators [8]. The fit monitoring data can be harnessed to facilitate “evidence-based”decision-making on the safe use of FFRs over extended periods.

Faceseal Pressure Changes During Use: The pressure distribution at the faceseal also changes during the typical use of an FFR in the field, i.e., when the user is talking, moving their head, bending down, smiling, yawning, or other motions [9, 10]. If the FFR does not respond to changes in the facial profile and loses contact with the face during those changes, there will be faceseal leakage compromising the fit and thereby the protection for the user. Thus, by monitoring the pressure distribution continuously, it is possible to detect changes in fit that could lead to faceseal leakage and alert the user to adjust the FFR in real-time to ensure the degree of protection for which the FFR is designed.

To summarize, the grand challenge in respiratory protection is to ensure the right balance between comfort and safety at all times during use while reducing the onus on the user to ensure the effectiveness of respiratory protection against inhalation hazards. Continuous fit monitoring of an FFR is the key to ensuring both the comfort and effectiveness of the device during use.

### Technology Development Process

Development of a fabric-based sensor network system: A fabric-based sensor network of the fit monitoring system was developed, the network including five sensors made out of conductive fabrics that fit around the faceseal of the FFR. The data buses carried the signals from the sensors to a signal processing module, which included a custom-made printed circuit board, a Featherboard™, and a Raspberry Pi. The developed software App runs on an Android tablet and displays the pressure at the sensors as a “heatmap” with the color changing according to the pressure. It also generates “alerts” triggered by changes in the pressure values (based on baseline pressure values and defined threshold levels) to denote faceseal leakage. The heatmap is also displayed on the web for remote monitoring.

Integration of the sensor network into the FFR for continuous fit monitoring: The next step was to identify a means to secure the sensor network into the FFR based on the following criteria: (i) It should not compromise the fit and performance (efficacy) of the FFR in protecting the user; (ii) it should stay in place securely during the use of the FFR; (iii) it should be unobtrusive and should not cause discomfort in breathability or skin allergies to the user; (iv) it should be easy to place the sensors in the desired locations on the faceseal; (v) it should be easy to take off before the disposal of the FFR; (vi) it should be easy to clean/decontaminate after use; and (vii) it should be reusable in another device. After evaluating various means to secure the sensor network based on the defined criteria, Silicone Scar Tape was chosen for the experimental implementation.

Identification of the optimal locations for placement of sensors on the user's face: As the first step in determining the number and optimal locations of sensors at the faceseal to monitor fit in real-time, the study investigated the potential points of failure leading to faceseal leakage caused by changes in the facial profile during use from the natural state (neutral facial expression with mouth closed) to talking, to smiling, and to yawning. These four stages were chosen to simulate the changes that could occur to the facial profile, and potentially cause faceseal leakage, during the eight-step QNFT protocol for fit testing using the PortaCount® Fit Tester in which the user is required to grimace, move the head side-to-side, bend up-and-down, and talk, among other activities [11]. Leakage around the nose area and under the chin is common especially when the wearer talks, smiles, or yawns. Therefore, to begin with, two sensors were placed on either side of the nose and one in the chin area. Additionally, one sensor each was placed symmetrically on either side of the face. Thus, the sensors at these five locations around the faceseal will ensure continuous monitoring of the fit as the facial profile changes when the FFR is in use.

The subject donned the FFR with the integrated sensor network and tests were conducted. The pressure values were displayed as a heatmap in the customized App running on the smart tablet; these values changed with facial movement demonstrating the functionality of the system to display pressure values in real-time. The sensors were manually moved around the faceseal until the pressure profile and the responses to changes in pressure were consistent. These tests confirmed: (i) the robustness and responsiveness of the continuous fit monitoring system; (ii) the process for integrating the sensor network securely into the FFR; and (iii) the ease with which sensors could be moved around when desired to determine the optimum location.

Performance Evaluation of the Technology: The evaluation of the developed technology was carried out in several phases starting with the assessment of the responsiveness of the fabric-based sensor network to changes in pressure. This was done by applying different weights to the sensors in the network and recording the pressure values displayed as ADC or analog-to-digital values in the heatmap on the App. Once the responsiveness of the sensor network and the performance of the end-to-end system were confirmed in the stand-alone mode, the efforts shifted to integration with N95 FFRs.

Assessment of Responsiveness of System and Optimum Placements of Sensors: Two types of N95 FFRs were chosen for the evaluation: 3M 8511 with an exhalation valve and 3M 8210 with no exhalation valve. The sensor network was integrated into (e.g., adhered or coupled to) the 3M 8511 using the scar tape. A series of tests were carried out to determine the optimal locations for the sensors and the number of sensors in the network. A subject donned the FFR with the integrated and/or adhered sensor network and tested the response of the system to changes in facial profile, e.g., while talking, smiling, and yawning.

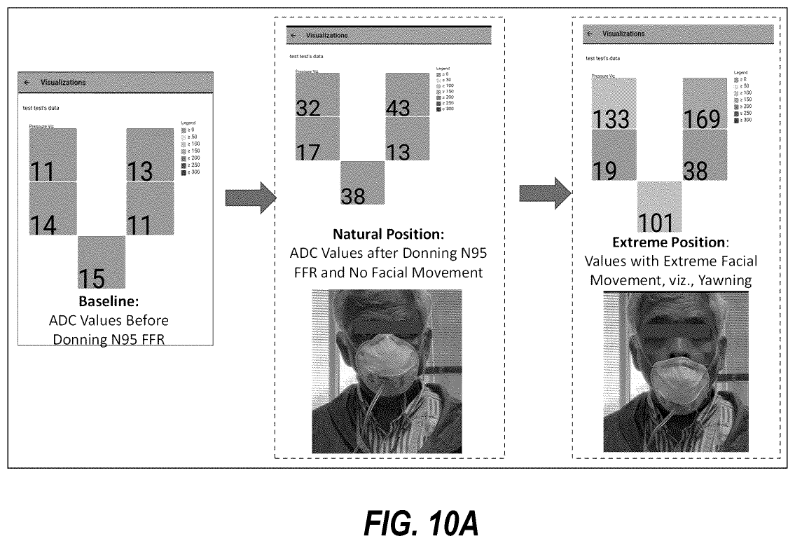

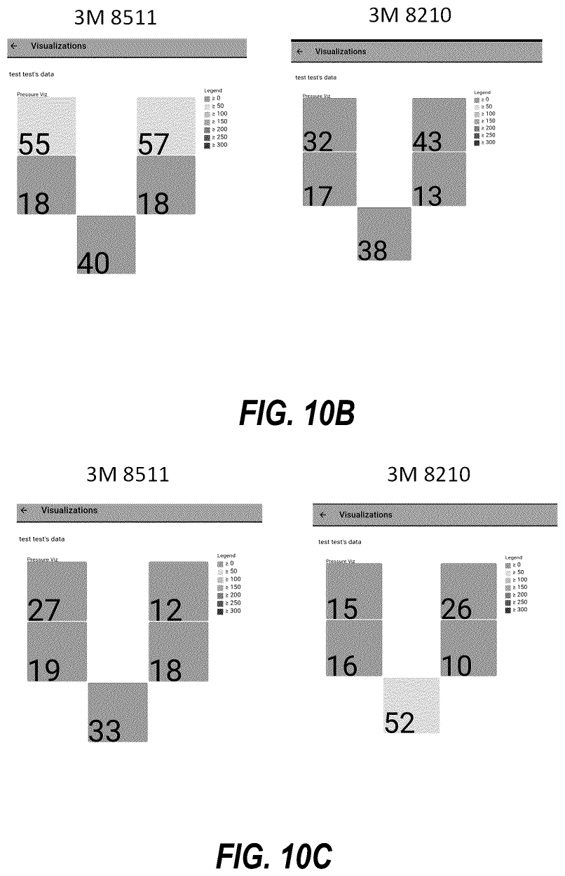

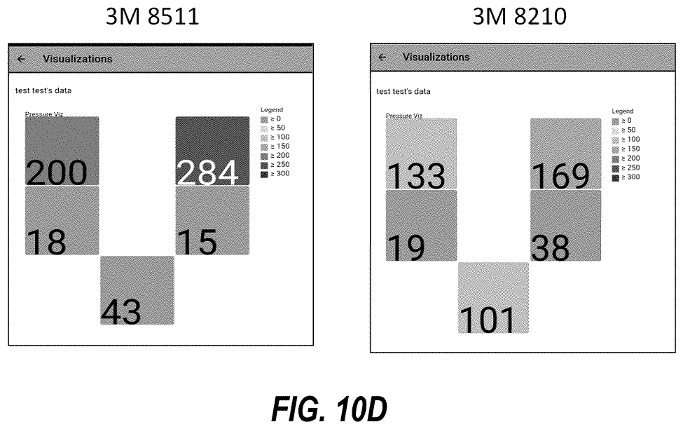

FIG. 10A shows the heatmaps of the pressures (ADC values) at the five sensors in the network that are displayed in the App on the smart tablet. The first panel shows the baseline values before the FFR was donned by the user. These values are nearly equal. The second panel shows the increase in pressure at the sensors, especially at the ones near the nose (the top two values) and the chin after the FFR has been donned. The third panel shows the significant changes in the pressure at three of the sensors. The increase in pressure values is caused by the movement of the FFR from its natural position during extreme facial movement, e.g., yawning. This test also demonstrated the sensitivity of the sensor network to changes in the user's facial movement. Based on a series of such tests with different locations of the sensors, the optimum placement was determined. These evaluations also validated the robustness of the means for integrating the sensors into the FFR securely while providing the flexibility to move them as needed. Another important outcome of these tests is the development of a preliminary generalized map for the optimum placements of the sensors in the FFR that could be applicable to users with different facial profiles. Once the performance of the system for monitoring the pressures at the faceseal and its responsiveness to changes in the facial profile was confirmed, the next step was to carry out a QNFT of the system using PortaCount™ Respirator Fit Tester 8084.

Quantitative Fit Testing: The key objectives behind QNFT with PortaCount were to demonstrate the ability of the N95 FFR with an integrated sensor network by showing that: (a) The fit and performance of the FFR were not compromised by the integration of the continuous fit monitoring system into the FFR. (b) The user passed the QNFT. (c) The fit of the FFR was monitored continuously and changes in pressures at the faceseal that occurred with different movements during the QNFT were recorded by the system. (d) A faceseal leakage that was introduced by disturbing the FFR on the face in the “Real-time Fit Check Test Mode” was recognized with the changes in the pressures at the faceseal and a notification was generated to alert the user to adjust the FFR to prevent the fit from being compromised. The pressure values returned to their baseline figures when the user adjusted the FFR after the induced faceseal leakage and these were recorded by the system. The system was responsive to the excess forces applied at the sensors that exceeded the baseline pressure profile required to maintain fit and the data could be harnessed to assess the potential for the occurrence of a pressure injury to the user, especially since users working in highly infectious environments (e.g., during COVID-19 in hospitals) tend to “tighten”their FFRs to prevent faceseal leakage.

This series of tests was conducted successfully on both types of FFRs and all the objectives were realized demonstrating the realization of an N95 FFR (with and without an exhalation valve) integrated with a continuous fit monitoring system. Following the successful tests, the subject's experience was assessed using the following criteria: (i) Wearability: differences in comfort and pressure at the faceseal between a regular N95 and the integrated system; (ii) Breathability; (iii) Sensitivity on the skin; and (iv) Ease of donning and doffing.

Results and Key Findings of the Study. First, the subject passed the QNFT using the PortaCount Fit Tester for both types of FFRs without the integrated continuous fit monitoring system. These results established that both FFRs were appropriate for evaluating their performance with the integrated continuous fit monitoring system.

Second, the user then passed the QNFT for both types of FFRs with the integrated continuous fit monitoring systems. As seen in the heatmap displayed on the App (FIG. 10B), the baseline pressure profiles on the same subject are different for the two FFRs. This demonstrates that the pressure exerted by the FFR depends on the type of FFR. This feature of the fit monitoring system bodes well for its potential use in the design and development of FFRs to optimize the pressure on the faceseal and enhance comfort for users while ensuring the fit of the FFR.

FIG. 10C shows the pressure distribution at the faceseal when a leakage was introduced during the Real-time Fit Check mode for both the FFRs on the same subject. The values at the top sensors at the nose are significantly lower than the values at the top sensors in the baseline pressure profile shown in FIG. 10B. This demonstrates the ability of the system to detect changes in pressure when a faceseal leakage occurs. Furthermore, an alert is generated by the system for the user to adjust the FFR. Following the adjustment, the pressure values return to their baseline values.

FIG. 10D shows the pressure distribution at the faceseal when external forces are applied to them during the testing. When compared to the baseline pressure profile in FIG. 10B, these values are significantly higher. These results demonstrate the ability of the system to detect excess pressures at the faceseal when users tighten the FFR out of fear when working in environments with inhalation hazards, such as the SARS-CoV-2 during the COVID-19 pandemic. Studies have shown that such tightening causes pressure injuries. By harnessing the data from the continuous fit monitoring system, such pressure injuries can be prevented.

### Conclusions

The other findings from the successful evaluations are as follows: The user passed the QNFT. The integrated continuous fit monitoring technology did not interfere with the administration of the test using the OSHA protocol. The fit and performance of both types of FFRs were not compromised by the integration of the continuous fit monitoring system. The same fabric-based sensor network could be used in two different FFRs. They were not damaged. They could be safely cleaned with cleaning wipes after use and their performance was not affected. The user's survey based on the evaluation criteria revealed that were was no discomfort when using the N95 with the integrated continuous fit monitoring system; breathability was not affected; there were no skin rashes or marks due to the sensor network. Donning and doffing required additional care to ensure careful handling of the data buses in the prototype that were hanging loosely. The color coding of the heatmaps provides a visual representation of the degree of pressure on the various sensors.

Thus, the findings confirmed the realization of N95 FFRs with integrated continuous fit monitoring that successfully passed the QNFT, recorded the pressures at the faceseal continuously during its use, alerted the user when there was faceseal leakage, and was responsive to changes in the facial profile during its use. The performance evaluation demonstrates the realization of a continuous fit monitoring system that was integrated successfully into commercial FFRs, which bodes well for the promise of the technology for commercialization and deployment in the real world.

### Example Computing System

It should be appreciated that the logical operations described above of the monitoring application and in the appendix can be implemented (1) as a sequence of computer-implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as state operations, acts, or modules. These operations, acts, and/or modules can be implemented in software, in firmware, in special purpose digital logic, in hardware, and any combination thereof. It should also be appreciated that more or fewer operations can be performed than shown in the figures and described herein. These operations can also be performed in a different order than those described herein.

The computer system is capable of executing the software components described herein for the exemplary method or systems. In an embodiment, the computing device may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computing device to provide the functionality of a number of servers that are not directly bound to the number of computers in the computing device. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or can be hired on an as-needed basis from a third-party provider. Some cloud computing environments may comprise cloud computing resources owned and operated by the enterprise as well as cloud computing resources hired and/or leased from a third-party provider.

In its most basic configuration, a computing device includes at least one processing unit and system memory. Depending on the exact configuration and type of computing device, system memory may be volatile (such as random-access memory (RAM)), non-volatile (such as read-only memory (ROM), flash memory, etc.), or some combination of the two.

The processing unit may be a programmable processor that performs arithmetic and logic operations necessary for the operation of the computing device. While only one processing unit is shown, multiple processors may be present. As used herein, processing unit and processor refers to a physical hardware device that executes encoded instructions for performing functions on inputs and creating outputs, including, for example, but not limited to, microprocessors (MCUs), microcontrollers, graphical processing units (GPUs), and application specific circuits (ASICs). Thus, while instructions may be discussed as executed by a processor, the instructions may be executed simultaneously, serially, or otherwise executed by one or multiple processors. The computing device may also include a bus or other communication mechanism for communicating information among various components of the computing device.

Computing devices may have additional features/functionality. For example, the computing device may include additional storage such as removable storage and non-removable storage including, but not limited to, magnetic or optical disks or tapes. Computing devices may also contain network connection(s) that allow the device to communicate with other devices, such as over the communication pathways described herein. The network connection(s) may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. Computing devices may also have input devices(s) such as keyboards, keypads, switches, dials, mice, trackballs, touch screens, voice recognizers, card readers, paper tape readers, or other well-known input devices. Output device(s) such as printers, video monitors, liquid crystal displays (LCDs), touch screen displays, displays, speakers, etc., may also be included. The additional devices may be connected to the bus in order to facilitate the communication of data among the components of the computing device. All these devices are well known in the art and need not be discussed at length here.

The processing unit may be configured to execute program code encoded in tangible, computer-readable media. Tangible, computer-readable media refers to any media that is capable of providing data that causes the computing device (i.e., a machine) to operate in a particular fashion. Various computer-readable media may be utilized to provide instructions to the processing unit for execution. Example tangible, computer-readable media may include but is not limited to volatile media, non-volatile media, removable media, and non-removable media implemented in any method or technology for storage of information such as computer-readable instructions, data structures, program modules, or other data. System memory, removable storage, and non-removable storage are all examples of tangible computer storage media. Example tangible, computer-readable recording media include, but are not limited to, an integrated circuit (e.g., field-programmable gate array or application-specific I.C.), a hard disk, an optical disk, a magneto-optical disk, a floppy disk, a magnetic tape, a holographic storage medium, a solid-state device, RAM, ROM, electrically erasable program read-only memory. (EEPROM), flash memory or other memory technology, CD-ROM, digital versatile disks (DVD) or other optical storage, magnetic cassettes, magnetic tape, magnetic disk storage or other magnetic storage devices.

In light of the above, it should be appreciated that many types of physical transformations take place in the computer architecture in order to store and execute the software components presented herein. It also should be appreciated that the computer architecture may include other types of computing devices, including hand-held computers, embedded computer systems, personal digital assistants, and other types of computing devices known to those skilled in the art.

In an example implementation, the processing unit may execute program code stored in the system memory. For example, the bus may carry data to the system memory, from which the processing unit receives and executes instructions. The data received by the system memory may optionally be stored on the removable storage or the non-removable storage before or after execution by the processing unit.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and it may be combined with hardware implementations.

### Configuration of Certain Implementations

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

As discussed herein, a “subject” may be any applicable human, animal, or another organism, living or dead, or other biological or molecular structure or chemical environment, and may relate to particular components of the subject, for instance, specific tissues or fluids of a subject (e.g., human tissue in a particular area of the body of a living subject), which may be in a particular location of the subject, referred to herein as an “area of interest” or a “region of interest.”

It should be appreciated that, as discussed herein, a subject may be a human or any animal. It should be appreciated that an animal may be a variety of any applicable type, including, but not limited thereto, mammal, veterinarian animal, livestock animal or pet type animal, etc. As an example, the animal may be a laboratory animal specifically selected to have certain characteristics similar to humans (e.g., rat, dog, pig, monkey), etc. It should be appreciated that the subject may be any applicable human patient, for example.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

All references cited and discussed in this specification are incorporated herein by reference in their entirety and to the same extent as if each reference was individually incorporated by reference.

### References

[1] NIOSH, https://www.cdc.gov/niosh/hierarchy-of-controls/about/index.html).

[2] Park, S., Tian, Y., Bergman, M., Pollard, J., Zhuang, Z., and Jayaraman, S., “Next Generation Custom-Fit Reusable Respiratory Protective Device with Continuous Fit Monitoring—Part I: Custom-Fit Design, Journal of the International Society of Respiratory Protection, Vol. 41, No. 1, 2024, 22-37.

[3] Roberge R, Niezgoda G, and Benson S. (2012) Analysis of Forces Generated by N95 Filtering Facepiece Respirator Tethering Devices: A Pilot Study, Journal of Occupational and Environmental Hygiene, 9 (8), 527-533.

[4] Yang J, Dai J, Zhuang Z. (2009) Simulating the interaction between a respirator and a headform using LS-DYNA. Computer-Aided Design Appl. 6(4):539-551.

[5] Radonovich L J, Cheng J, Shenal B V, Hodgson M, and Bender B S. (2009) Respirator Tolerance in Health Care Workers. Journal of the American Medical Association. 301(1):36-38. doi:10.1001/jama.2008.894.

[6] Lam S C, Lee J K L, Yau S Y, and Charm C Y C. (2011) Sensitivity and specificity of the user-seal-check in determining the fit of N95 respirators, Journal of Hospital Infection 77 252-256. https://doi.org/10.1016/j.jhin.2010.09.034.

[7] Stokowski L A. (2020) A Step-by-Step Guide to Preventing PPE-Related Skin Damage. MedScape. Retrieved from https://www.medscape.com/viewarticle/929590.

[8] National Pressure Injury Advisory Panel. (2020) https://cdn.ymaws.com/npiap.com/resource/resmgr/position_statements/NPIAP_Mask_Injury_Infograp.pdf).

[9] Jayaraman, S., Next Generation Custom-Fit Reusable N95 Respirator with Fit Monitoring, Final Technical Report, SJ-TR-CDC-06-22. Jun. 30, 2022.

[10] Park, S., Tian, Y., Bergman, M., Pollard, J., Zhuang, Z., and Jayaraman, S., “Next Generation Custom-Fit Reusable Respiratory Protective Device with Continuous Fit Monitoring—Part II: Continuous Fit Monitoring, Journal of the International Society of Respiratory Protection, Vol. 41, No. 1, July 2024, pp. 38-56.

[11] OSHA 1910.134 App A, Fit Testing Procedures (Mandatory), https://www.osha.gov/laws regs/regulations/standardnumber/1910/1910.134AppA.

1. A system comprising:
a sensor network configured to couple to an inner surface of a respiratory protective device adjacent to a periphery of the respiratory protective device, wherein the respiratory protective device maintains a breathable filter covering over a facial region of a user, the sensor network comprising:
at least one sensor, including a first sensor, disposed adjacent to the periphery of the respiratory protective device, the at least one sensor configured to detect pressure or proximity between the periphery of the respiratory protective device and the facial region of the user; and
a signal processing module in operative communication with the at least one sensor, the signal processing module configured to continuously receive and process pressure and/or proximity data from the at least one sensor to produce pressure values and monitor the fit of the respiratory protective device.

2. The system of claim 1, wherein the signal processing module further comprises a communication interface configured to wirelessly communicate with a controller, wherein the controller is configured to (i) receive the pressure values, (ii) generate a notification based on the pressure values, and (iii) relay the notification to activate one of a display on a user interface, an audio device, or a haptic device.

3. The system of claim 2, wherein the controller is configured to output the pressure values to a monitoring application.

4. The system of claim 2, wherein the controller is configured to generate an alert notification upon detecting that the pressure values from one or more sensors of the at least one sensor have dropped below a threshold value.

5. The system of claim 2, wherein the controller is configured to generate an alert notification upon detecting that the pressure values from one or more sensors of the at least one sensor have risen above a threshold value.

6. The system of claim 2, wherein the controller is configured to remove an alert notification upon detecting that the pressure values from a sensor of the at least one sensor have returned to a predetermined range.

7. The system of claim 1, wherein the sensor network is adhered to the respiratory protective device with an adhesive material such that the first sensor of the at least one sensor is adhered to a customizable fixed position along the periphery of the respiratory protective device.

8. The system of claim 1, wherein the sensor network is disposed on a peripheral platform of the respiratory protective device, the peripheral platform including wings or flaps for holding each sensor of the at least one sensor.

9. The system of claim 8, wherein the peripheral platform is integrated into the respiratory device.

10. The system of claim 1, wherein the first sensor is a fabric-based sensor comprising:
a first conductive fabric layer and a second conductive fabric layer separated by a resistive fabric layer;
a first base layer coupled to the first conductive fabric layer; and
a second base layer coupled to the second conductive fabric layer.

11. The system of claim 10, wherein the first base layer is a typical nonconductive fabric layer, wherein the first base layer is coupled to the first conductive fabric layer via adhesive, sewing, or bonding.

12. The system of claim 10, further comprising a first fabric frame disposed between the first conductive fabric layer coupled to the first base layer and the resistive fabric layer, the first fabric frame configured to provide enhanced structural integrity to the first sensor.

13. The system of claim 10, wherein the first and second conductive fabric layers have a surface resistivity less than 1 Ohm/cm².

14. The system of claim 10, wherein the resistive fabric layer has a surface resistivity of greater than 31,000 Ohm/cm².

15. The system of claim 10, wherein the first conductive fabric layer is coupled to the signal processing module via a data wire, and the second conductive fabric layer is coupled to the signal processing module via a power wire.

16. The system of claim 1, wherein each sensor of the at least one sensor is adhered at a customized location on the respiratory protective device based at least on the facial region of the user.

17. The system of claim 16, the customized location on the respiratory protective device is one or more of a nose position, an upper-cheek position, a mid-cheek position, and a chin position.

18. The system of claim 1, wherein the respiratory protective device is an N95 respirator.

19. The system of claim 1, wherein the sensor network is removable from the respiratory protective device, capable of decontamination, and reusable.

20. A method of monitoring fit of a respiratory protective device, the method comprising:
providing a system comprising:
a sensor network configured to couple to an inner surface of a respiratory protective device adjacent to a periphery of the respiratory protective device, wherein the respiratory protective device maintains a breathable filter covering over a facial region of a user, the sensor network comprising:
at least one sensor, including a first sensor, disposed adjacent to the periphery of the respiratory protective device, the at least one sensor configured to detect pressure or proximity between the periphery of the respiratory protective device and the facial region of the user; and
a signal processing module in operative communication with the at least one sensor, the signal processing module comprising a communication interface configured to wirelessly communication with a controller;
continuously receiving, via the signal processing module, pressure and/or proximity data from the at least one sensor;
continuously receiving, via the controller, pressure values from the signal processing module, and
generating, via the controller, a notification based on the pressure values.

21.-29. (canceled)
